(19) United States
(12) Patent Application Publication
(10) Pub. No.: US 2025/0067964 A1
(43) Pub. Date: Feb. 27, 2025

(54) VARIABLE MAGNIFICATION OPTICAL SYSTEM, OPTICAL DEVICE, AND METHOD FOR MANUFACTURING VARIABLE MAGNIFICATION OPTICAL SYSTEM

(71) Applicant: NIKON CORPORATION, Tokyo (JP)

(72) Inventor: Takuro ONO, Tokyo (JP)

(21) Appl. No.: 18/891,529

(22) Filed: Sep. 20, 2024

Related U.S. Application Data
(63) Continuation of application No. PCT/JP2023/012935, filed on Mar. 29, 2023.

(30) Foreign Application Priority Data
Mar. 29, 2022 (JP) 2022-053481

(51) Int. Cl. G02B 13/00; G02B 15/14

(52) U.S. Cl. CPC G02B 13/009; G02B 15/1461

(57) ABSTRACT

A variable magnification optical system comprising a first lens group, a second lens group, a third lens group, and a rear group in order from object side is configured so that at varying magnification the distances between adjacent lens groups are varied; at a predetermined object distance the variable magnification optical system has focused states with different amounts of aberration; the rear group includes a first focusing lens group and a second focusing lens group disposed closer to an image side than the first focusing lens group, the first and second focusing lens groups moving along different trajectories at focusing; at the object distance the first and second focusing lens groups move at transition from a first focused state to a second focused state; and the following conditional expression is satisfied:

−6.80<f1/f2<−0.05

where f1 and f2 are the focal lengths of the first and second lens groups, respectively.

### CROSS-REFERENCE TO RELATED APPLICATIONS

This application is a continuation of International Patent Application No. PCT/JP2023/012935 filed Mar. 29, 2023, which claims priority from Japanese Patent Application No. 2022-053481 filed Mar. 29, 2022, which are incorporated herein by reference.

### FIELD

The present disclosure relates to a variable magnification optical system, an optical device, and a method for manufacturing a variable magnification optical system.

### BACKGROUND

Variable magnification optical systems used in optical devices, such as cameras for photographs, electronic still cameras, and video cameras, have been proposed (see, e.g., Japanese Unexamined Patent Publication No. 2018-097240).

### SUMMARY

A variable magnification optical system of the present disclosure comprises a first lens group, a second lens group, a third lens group, and a rear group in order from an object side; at varying magnification the distances between adjacent lens groups are varied; at a predetermined object distance the variable magnification optical system has a plurality of focused states with different amounts of aberration; the rear group includes a first focusing lens group and a second focusing lens group disposed closer to an image side than the first focusing lens group, the first and second focusing lens groups moving along different trajectories at focusing; at the predetermined object distance the first and second focusing lens groups move at transition from a first focused state to a second focused state, the first and second focused states being among the plurality of focused states and having different amounts of aberration; the variable magnification optical system satisfies the following conditional expression.

−6.80<f1/f2<−0.05

where
f1: the focal length of the first lens group
f2: the focal length of the second lens group

A variable magnification optical system of the present disclosure comprises a first lens group, a second lens group, a third lens group, and a rear group in order from an object side; at varying magnification the distances between adjacent lens groups are varied; at a predetermined object distance the variable magnification optical system has a plurality of focused states with different amounts of aberration; the rear group includes a focusing lens group that moves at focusing, and a variable aberration lens group that differs from the focusing lens group and that moves at the predetermined object distance at transition from a first focused state to a second focused state, the first and second focused states being among the plurality of focused states and having different amounts of aberration.

A method for manufacturing a variable magnification optical system of the present disclosure is a method for manufacturing a variable magnification optical system comprising a first lens group, a second lens group, a third lens group, and a rear group in order from an object side. The method includes configuring the lens groups so that at varying magnification the distances between adjacent lens groups are varied; at a predetermined object distance the variable magnification optical system has a plurality of focused states with different amounts of aberration; the rear group includes a first focusing lens group and a second focusing lens group disposed closer to an image side than the first focusing lens group, the first and second focusing lens groups moving along different trajectories at focusing; at the predetermined object distance the first and second focusing lens groups move at transition from a first focused state to a second focused state with a different amount of aberration; and the following conditional expression is satisfied.

$$- 6.80 < f 1 / f 2 < - 0.05$$

where
f1: the focal length of the first lens group
f2: the focal length of the second lens group

### BRIEF DESCRIPTION OF DRAWINGS

FIG. 1 is a cross-sectional view of a variable magnification optical system of a first example at focusing on an object at infinity in the wide-angle end state.

FIG. 2A-H show aberrations of the variable magnification optical system of the first example.

FIG. 3 is a cross-sectional view of a variable magnification optical system of a second example at focusing on an object at infinity in the wide-angle end state.

FIG. 4A-H show aberrations of the variable magnification optical system of the second example.

FIG. 5 is a cross-sectional view of a variable magnification optical system of a third example at focusing on an object at infinity in the wide-angle end state.

FIG. 6A-H show aberrations of the variable magnification optical system of the third example.

FIG. 7 is a cross-sectional view of a variable magnification optical system of a fourth example at focusing on an object at infinity in the wide-angle end state.

FIG. 8A-H show aberrations of the variable magnification optical system of the fourth example.

FIG. 9 is a cross-sectional view of a variable magnification optical system of a fifth example at focusing on an object at infinity in the wide-angle end state.

FIG. 10A-H show aberrations of the variable magnification optical system of the fifth example.

FIG. 11 is a cross-sectional view of a variable magnification optical system of a sixth example at focusing on an object at infinity in the wide-angle end state.

FIG. 12A-H show aberrations of the variable magnification optical system of the sixth example.

FIG. 13 is a cross-sectional view of a variable magnification optical system of a seventh example at focusing on an object at infinity in the wide-angle end state.

FIG. 14A-H show aberrations of the variable magnification optical system of the seventh example.

FIG. 15 is a cross-sectional view of a variable magnification optical system of an eighth example at focusing on an object at infinity in the wide-angle end state.

FIG. 16A-H show aberrations of the variable magnification optical system of the eighth example.

FIG. 17 is a cross-sectional view of a variable magnification optical system of a ninth example at focusing on an object at infinity in the wide-angle end state.

FIG. 18A-H show aberrations of the variable magnification optical system of the ninth example.

FIG. 19 schematically shows a camera including a variable magnification optical system of the embodiment.

FIG. 20 is a flowchart outlining a first method for manufacturing a variable magnification optical system of the embodiment.

FIG. 21 is a flowchart outlining a second method for manufacturing a variable magnification optical system of the embodiment.

### DESCRIPTION OF EMBODIMENTS

The following describes a variable magnification optical system, an optical device, and a method for manufacturing a variable magnification optical system of an embodiment of the present application.

A variable magnification optical system of the present embodiment comprises a first lens group, a second lens group, a third lens group, and a rear group in order from an object side; at varying magnification the distances between adjacent lens groups are varied; at a predetermined object distance the variable magnification optical system has a plurality of focused states with different amounts of aberration; the rear group includes a first focusing lens group and a second focusing lens group disposed closer to an image side than the first focusing lens group, the first and second focusing lens groups moving along different trajectories at focusing; at the predetermined object distance the first and second focusing lens groups move at transition from a first focused state to a second focused state, the first and second focused states being among the plurality of focused states and having different amounts of aberration; the variable magnification optical system satisfies the following conditional expression.

$$- 6.80 < f 1 / f 2 < - 0.05 \qquad ( 1 )$$

where
f1: the focal length of the first lens group
f2: the focal length of the second lens group

Conditional expression (1) restricts the ratio between the focal lengths of the first and second lens groups. The variable magnification optical system of the present embodiment, which satisfies conditional expression (1), can reduce variations in aberrations, including spherical aberration, appropriately at varying magnification.

If the value of conditional expression (1) is greater than the upper limit in the variable magnification optical system of the present embodiment, the second lens group will have too strong refractive power, making it difficult to reduce variations in aberrations, including spherical aberration, appropriately at varying magnification.

In the variable magnification optical system of the present embodiment, the effect of the present embodiment can be ensured by setting the upper limit of conditional expression (1) to −0.05. To further ensure the effect of the present embodiment, the upper limit of conditional expression (1) is preferably set to −0.10, −0.25, −0.40, −1.00, −1.50, −2.00, or −2.50, more preferably to −3.00.

If the value of conditional expression (1) is less than the lower limit in the variable magnification optical system of the present embodiment, the first lens group will have too strong refractive power, making it difficult to reduce variations in aberrations, including spherical aberration, appropriately at varying magnification.

In the variable magnification optical system of the present embodiment, the effect of the present embodiment can be ensured by setting the lower limit of conditional expression (1) to −6.80. To further ensure the effect of the present embodiment, the lower limit of conditional expression (1) is preferably set to −6.50, −6.00, −5.50, or −5.00, more preferably to −4.75.

A variable magnification optical system having the above configuration and satisfying conditional expression (1) can change from a first focused state to a second focused state at a predetermined object distance and reduce variations in aberrations, including spherical aberration, appropriately at varying magnification.

In the variable magnification optical system of the present embodiment, at the predetermined object distance the first and second focusing lens groups preferably move in the same direction at transition from the first focused state to the second focused state.

The variable magnification optical system of the present embodiment can reduce variations in spherical aberration and curvature of field appropriately at transition from the first focused state to the second focused state, by the first and second focusing lens groups moving in the same direction.

In the variable magnification optical system of the present embodiment, one of the first and second focusing lens groups preferably has positive refractive power, and the other preferably has negative refractive power.

The variable magnification optical system of the present embodiment can reduce variations in spherical aberration and curvature of field appropriately at transition from the first focused state to the second focused state, by one of the first and second focusing lens groups having positive refractive power and the other having negative refractive power.

In the variable magnification optical system of the present embodiment, the first and second focusing lens groups are preferably disposed between an aperture stop and an image plane.

The variable magnification optical system of the present embodiment can reduce variations in aberrations other than spherical aberration appropriately at transition from the first focused state to the second focused state, by the first and second focusing lens groups being disposed between an aperture stop and an image plane.

The variable magnification optical system of the present embodiment preferably satisfies the following conditional expressions.

$$- 0.2 < Dsr 1 W / TLW < 0 \text{.20} \qquad ( 2 )$$

$$- 0.25 < Dsr 1 T / TLT < 0.25 \qquad ( 3 )$$

where
Dsr1W: the distance on the optical axis between the aperture stop and an object-side surface of a lens disposed closest to the object side in the first focusing lens group at focusing on infinity in the wide-angle end state
TLW: the total length of the optical system in the wide-angle end state
Dsr1T: the distance on the optical axis between the aperture stop and an object-side surface of a lens disposed closest to the object side in the first focusing lens group at focusing on infinity in the telephoto end state
TLT: the total length of the optical system in the telephoto end state

The variable magnification optical system of the present embodiment, which satisfies conditional expressions (2) and (3), can vary the amount of spherical aberration appropriately and reduce variations in other aberrations appropriately at transition from the first focused state to the second focused state.

Conditional expression (2) restricts the ratio of the distance on the optical axis between the aperture stop and an object-side surface of a lens disposed closest to the object side in the first focusing lens group at focusing on infinity in the wide-angle end state to the total length of the optical system in the wide-angle end state. The variable magnification optical system of the present embodiment, which satisfies conditional expression (2), can vary the amount of spherical aberration appropriately and reduce variations in other aberrations appropriately.

If the value of conditional expression (2) is greater than the upper limit in the variable magnification optical system of the present embodiment, it will be difficult to reduce variations in other aberrations appropriately when the amount of spherical aberration is appropriately varied.

In the variable magnification optical system of the present embodiment, the effect of the present embodiment can be ensured by setting the upper limit of conditional expression (2) to 0.20. To further ensure the effect of the present embodiment, the upper limit of conditional expression (2) is preferably set to 0.18, 0.16, or 0.14, more preferably to 0.13.

If the value of conditional expression (2) is less than the lower limit in the variable magnification optical system of the present embodiment, it will be difficult to reduce variations in other aberrations appropriately when the amount of spherical aberration is appropriately varied.

In the variable magnification optical system of the present embodiment, the effect of the present embodiment can be ensured by setting the lower limit of conditional expression (2) to −0.20. To further ensure the effect of the present embodiment, the lower limit of conditional expression (2) is preferably set to −0.16, −0.12, −0.08, −0.04, −0.02, or 0.00, more preferably to 0.04.

Conditional expression (3) restricts the ratio of the distance on the optical axis between the aperture stop and an object-side surface of a lens disposed closest to the object side in the first focusing lens group at focusing on infinity in the telephoto end state to the total length of the optical system in the telephoto end state. The variable magnification optical system of the present embodiment, which satisfies conditional expression (3), can vary the amount of spherical aberration appropriately and reduce variations in other aberrations appropriately.

If the value of conditional expression (3) is greater than the upper limit in the variable magnification optical system of the present embodiment, it will be difficult to reduce variations in other aberrations appropriately when the amount of spherical aberration is appropriately varied.

In the variable magnification optical system of the present embodiment, the effect of the present embodiment can be ensured by setting the upper limit of conditional expression (3) to 0.25. To further ensure the effect of the present embodiment, the upper limit of conditional expression (3) is preferably set to 0.22, 0.20, 0.18, or 0.16, more preferably to 0.14.

If the value of conditional expression (3) is less than the lower limit in the variable magnification optical system of the present embodiment, it will be difficult to reduce variations in other aberrations appropriately when the amount of spherical aberration is appropriately varied.

In the variable magnification optical system of the present embodiment, the effect of the present embodiment can be ensured by setting the lower limit of conditional expression (3) to −0.25. To further ensure the effect of the present embodiment, the lower limit of conditional expression (3) is preferably set to −0.22, −0.18, −0.14, −0.10, −0.06, −0.02, 0.02, or 0.06, more preferably to 0.10.

The variable magnification optical system of the present embodiment preferably satisfies the following conditional expressions.

$$0.10 < Dsr 2 W / TLW < 0 \text{.40} \qquad ( 4 )$$

$$0.1 < Dsr 2 T / TLT < 0.40 \qquad ( 5 )$$

where
Dsr2W: the distance on the optical axis between the aperture stop and an object-side surface of a lens disposed closest to the object side in the second focusing lens group at focusing on infinity in the wide-angle end state
TLW: the total length of the optical system in the wide-angle end state
Dsr2T: the distance on the optical axis between the aperture stop and an object-side surface of a lens disposed closest to the object side in the second focusing lens group at focusing on infinity in the telephoto end state
TLT: the total length of the optical system in the telephoto end state

The variable magnification optical system of the present embodiment, which satisfies conditional expressions (4) and (5), can vary the amount of spherical aberration appropriately and reduce variations in other aberrations appropriately at transition from the first focused state to the second focused state.

Conditional expression (4) restricts the ratio of the distance on the optical axis between the aperture stop and an object-side surface of a lens disposed closest to the object side in the second focusing lens group at focusing on infinity in the wide-angle end state to the total length of the optical system in the wide-angle end state. The variable magnification optical system of the present embodiment, which satisfies conditional expression (4), can vary the amount of spherical aberration appropriately and reduce variations in other aberrations appropriately.

If the value of conditional expression (4) is greater than the upper limit in the variable magnification optical system of the present embodiment, the lenses of the second focusing lens group will increase in diameter and weight. This will increase the load of an actuator that moves the second focusing lens group to focus, making it difficult to move the second focusing lens group appropriately.

In the variable magnification optical system of the present embodiment, the effect of the present embodiment can be ensured by setting the upper limit of conditional expression (4) to 0.40. To further ensure the effect of the present embodiment, the upper limit of conditional expression (4) is preferably set to 0.36, 0.32, or 0.28, more preferably to 0.26.

If the value of conditional expression (4) is less than the lower limit in the variable magnification optical system of the present embodiment, it will be difficult to reduce variations in other aberrations appropriately when the amount of spherical aberration is appropriately varied.

In the variable magnification optical system of the present embodiment, the effect of the present embodiment can be ensured by setting the lower limit of conditional expression (4) to 0.10. To further ensure the effect of the present embodiment, the lower limit of conditional expression (4) is preferably set to 0.11 or 0.12, more preferably to 0.13.

Conditional expression (5) restricts the ratio of the distance on the optical axis between the aperture stop and an object-side surface of a lens disposed closest to the object side in the second focusing lens group at focusing on infinity in the telephoto end state to the total length of the optical system in the telephoto end state. The variable magnification optical system of the present embodiment, which satisfies conditional expression (5), can vary the amount of spherical aberration appropriately and reduce variations in other aberrations appropriately.

If the value of conditional expression (5) is greater than the upper limit in the variable magnification optical system of the present embodiment, the lenses of the second focusing lens group will increase in diameter and weight. This will increase the load of an actuator that moves the second focusing lens group to focus, making it difficult to move the second focusing lens group appropriately.

In the variable magnification optical system of the present embodiment, the effect of the present embodiment can be ensured by setting the upper limit of conditional expression (5) to 0.40. To further ensure the effect of the present embodiment, the upper limit of conditional expression (5) is preferably set to 0.36, 0.32, or 0.28, more preferably to 0.26.

If the value of conditional expression (5) is less than the lower limit in the variable magnification optical system of the present embodiment, it will be difficult to reduce variations in other aberrations appropriately when the amount of spherical aberration is appropriately varied.

In the variable magnification optical system of the present embodiment, the effect of the present embodiment can be ensured by setting the lower limit of conditional expression (5) to 0.10. To further ensure the effect of the present embodiment, the lower limit of conditional expression (5) is preferably set to 0.11 or 0.12, more preferably to 0.13.

The variable magnification optical system of the present embodiment preferably satisfies the following conditional expressions.

$$Dsr 1 W / DsiW < 0 \text{.30} \qquad ( 6 )$$

$$Dsr 1 T / DsiT < 0.35 \qquad ( 7 )$$

where
DsiW: the distance on the optical axis between the aperture stop and the image plane at focusing on infinity in the wide-angle end state
DsiT: the distance on the optical axis between the aperture stop and the image plane at focusing on infinity in the telephoto end state

The variable magnification optical system of the present embodiment, which satisfies conditional expressions (6) and (7), can vary the amount of spherical aberration appropriately and reduce variations in other aberrations appropriately at transition from the first focused state to the second focused state.

Conditional expression (6) restricts the ratio of the distance on the optical axis between the aperture stop and an object-side surface of a lens disposed closest to the object side in the first focusing lens group at focusing on infinity in the wide-angle end state to the distance on the optical axis between the aperture stop and the image plane at focusing on infinity in the wide-angle end state. The variable magnification optical system of the present embodiment, which satisfies conditional expression (6), can vary the amount of spherical aberration appropriately and reduce variations in other aberrations appropriately at transition from the first focused state to the second focused state.

If the value of conditional expression (6) is greater than the upper limit in the variable magnification optical system of the present embodiment, it will be difficult to reduce variations in other aberrations appropriately when the amount of spherical aberration is appropriately varied.

In the variable magnification optical system of the present embodiment, the effect of the present embodiment can be ensured by setting the upper limit of conditional expression (6) to 0.30. To further ensure the effect of the present embodiment, the upper limit of conditional expression (6) is preferably set to 0.29, more preferably to 0.28.

In the variable magnification optical system of the present embodiment, the lower limit of conditional expression (6), if it is set, is preferably set to −0.30 or −0.10, more preferably to 0.00.

Conditional expression (7) restricts the ratio of the distance on the optical axis between the aperture stop and an object-side surface of a lens disposed closest to the object side in the first focusing lens group at focusing on infinity in the telephoto end state to the distance on the optical axis between the aperture stop and the image plane at focusing on infinity in the telephoto end state. The variable magnification optical system of the present embodiment, which satisfies conditional expression (7), can vary the amount of spherical aberration appropriately and reduce variations in other aberrations appropriately at transition from the first focused state to the second focused state.

If the value of conditional expression (7) is greater than the upper limit in the variable magnification optical system of the present embodiment, it will be difficult to reduce variations in other aberrations appropriately when the amount of spherical aberration is appropriately varied.

In the variable magnification optical system of the present embodiment, the effect of the present embodiment can be ensured by setting the upper limit of conditional expression (7) to 0.35. To further ensure the effect of the present embodiment, the upper limit of conditional expression (7) is preferably set to 0.34 or 0.33, more preferably to 0.32.

In the variable magnification optical system of the present embodiment, the lower limit of conditional expression (7), if it is set, is preferably set to −0.40 or −0.20, more preferably to 0.00.

The variable magnification optical system of the present embodiment preferably satisfies the following conditional expressions.

$$0.20 < Dsr 2 W / DsiW \qquad ( 8 )$$

$$0.25 < Dsr 2 T / DsiT \qquad ( 9 )$$

where
DsiW: the distance on the optical axis between the aperture stop and the image plane at focusing on infinity in the wide-angle end state
DsiT: the distance on the optical axis between the aperture stop and the image plane at focusing on infinity in the telephoto end state

The variable magnification optical system of the present embodiment, which satisfies conditional expressions (8) and (9), can vary the amount of spherical aberration appropriately and reduce variations in other aberrations appropriately at transition from the first focused state to the second focused state.

Conditional expression (8) restricts the ratio of the distance on the optical axis between the aperture stop and an object-side surface of a lens disposed closest to the object side in the second focusing lens group at focusing on infinity in the wide-angle end state to the distance on the optical axis between the aperture stop and the image plane at focusing on infinity in the wide-angle end state. The variable magnification optical system of the present embodiment, which satisfies conditional expression (8), can vary the amount of spherical aberration appropriately and reduce variations in other aberrations appropriately at transition from the first focused state to the second focused state.

If the value of conditional expression (8) is less than the lower limit in the variable magnification optical system of the present embodiment, it will be difficult to reduce variations in other aberrations appropriately when the amount of spherical aberration is appropriately varied.

In the variable magnification optical system of the present embodiment, the effect of the present embodiment can be ensured by setting the lower limit of conditional expression (8) to 0.20. To further ensure the effect of the present embodiment, the lower limit of conditional expression (8) is preferably set to 0.22, 0.24, 0.26, or 0.28, more preferably to 0.30.

In the variable magnification optical system of the present embodiment, the upper limit of conditional expression (8), if it is set, is preferably set to 5.00 or 2.50, more preferably to 1.00.

Conditional expression (9) restricts the ratio of the distance on the optical axis between the aperture stop and an object-side surface of a lens disposed closest to the object side in the second focusing lens group at focusing on infinity in the telephoto end state to the distance on the optical axis between the aperture stop and the image plane at focusing on infinity in the telephoto end state. The variable magnification optical system of the present embodiment, which satisfies conditional expression (9), can vary the amount of spherical aberration appropriately and reduce variations in other aberrations appropriately at transition from the first focused state to the second focused state.

If the value of conditional expression (9) is less than the lower limit in the variable magnification optical system of the present embodiment, it will be difficult to reduce variations in other aberrations appropriately when the amount of spherical aberration is appropriately varied.

In the variable magnification optical system of the present embodiment, the effect of the present embodiment can be ensured by setting the lower limit of conditional expression (9) to 0.25. To further ensure the effect of the present embodiment, the lower limit of conditional expression (9) is preferably set to 0.26, 0.27, 0.28, or 0.29, more preferably to 0.30.

In the variable magnification optical system of the present embodiment, the upper limit of conditional expression (9), if it is set, is preferably set to 5.00 or 2.50, more preferably to 1.00.

In the variable magnification optical system of the present embodiment, at least one of the first and second focusing lens groups preferably includes at least one lens Z satisfying the following conditional expressions:

$$n d L Z + ( 0.014 \; 25 \times vdLZ ) < 2.25 \qquad ( 10 )$$

$$vdLZ < 35 \text{.00} \qquad ( 11 )$$

$$0.702 < θ gFLZ + ( 0.003 \; 16 \times vdLZ ) \qquad ( 12 )$$

where
ndLZ: the refractive index of the lens Z at d-line
vdLZ: the Abbe number of the lens Z based on d-line
θgFLZ: the partial dispersion ratio of the lens Z defined by the following expression:

θgFLZ=(ngLZ−nFLZ)/(nFLZ−nCLZ)

where ngLZ, nFLZ, and nCLZ denote the refractive indices of the lens Z at g-line, F-line, and C-line, respectively.

The variable magnification optical system of the present embodiment can correct aberrations, including chromatic aberration, appropriately by at least one of the first and second focusing lens groups including at least one lens Z.

The variable magnification optical system of the present embodiment can prevent the Petzval sum from being too small and correct curvature of field favorably by setting the value of conditional expression (10) less than the upper limit. The effect of the present embodiment can be ensured by setting the upper limit of conditional expression (10) to 2.250. To further ensure the effect of the present embodiment, the upper limit of conditional expression (10) is preferably set to 2.235, 2.225, or 2.215, more preferably to 2.210.

The variable magnification optical system of the present embodiment can correct second-order dispersion of axial chromatic aberration favorably by setting the value of conditional expression (11) less than the upper limit. The effect of the present embodiment can be ensured by setting the upper limit of conditional expression (11) to 35.00. To further ensure the effect of the present embodiment, the upper limit of conditional expression (11) is preferably set to 33.50, 32.50, 30.00, 28.50, 25.00, 23.50, or 21.00, more preferably to 20.00.

The variable magnification optical system of the present embodiment can correct second-order dispersion of axial chromatic aberration favorably by setting the value of conditional expression (12) greater than the lower limit. The effect of the present embodiment can be ensured by setting the lower limit of conditional expression (12) to 0.702. To further ensure the effect of the present embodiment, the lower limit of conditional expression (12) is preferably set to 0.705 or 0.708, more preferably to 0.710.

In the variable magnification optical system of the present embodiment, the first or second focusing lens group preferably includes at least one lens satisfying the following conditional expression.

$$1.6 < ndF < 2. \qquad ( 13 )$$

where
ndF: the refractive index at d-line of the lens included in the first or second focusing lens group

The variable magnification optical system of the present embodiment can prevent optical performance from being low, by the first or second focusing lens group including at least one lens satisfying conditional expression (13).

The use of a lens that makes the value of conditional expression (13) greater than the upper limit in the first or second focusing lens group results in the lens being sensitive, so that manufacturing errors are likely to cause low optical performance.

In the variable magnification optical system of the present embodiment, the effect of the present embodiment can be ensured by setting the upper limit of conditional expression (13) to 2.00. To further ensure the effect of the present embodiment, the upper limit of conditional expression (13) is preferably set to 1.99, 1.98, or 1.97, more preferably to 1.96.

The use of a lens that makes the value of conditional expression (13) less than the lower limit in the first or second focusing lens group requires the curvature of the lens to be increased. This causes higher-order aberration and low optical performance.

In the variable magnification optical system of the present embodiment, the effect of the present embodiment can be ensured by setting the lower limit of conditional expression (13) to 1.60. To further ensure the effect of the present embodiment, the lower limit of conditional expression (13) is preferably set to 1.56, 1.52, 1.48, or 1.44, more preferably to 1.40.

The variable magnification optical system of the present embodiment preferably satisfies the following conditional expression.

$$0.00 < \vert fF 1 / fF 2 \vert < 4. 00 \qquad ( 14 )$$

where
fF1: the focal length of the first focusing lens group
fF2: the focal length of the second focusing lens group

Conditional expression (14) restricts the ratio between the focal lengths of the first and second focusing lens groups. The variable magnification optical system of the present embodiment, which satisfies conditional expression (14), can correct aberrations appropriately.

If the value of conditional expression (14) is greater than the upper limit in the variable magnification optical system of the present embodiment, the first focusing lens group will have too strong refractive power, making it difficult to correct aberrations.

In the variable magnification optical system of the present embodiment, the effect of the present embodiment can be ensured by setting the upper limit of conditional expression (14) to 4.00. To further ensure the effect of the present embodiment, the upper limit of conditional expression (14) is preferably set to 3.86, 3.71, 3.57, or 3.42, more preferably to 3.28.

A variable magnification optical system of the present embodiment comprises a first lens group, a second lens group, a third lens group, and a rear group in order from an object side; at varying magnification the distances between adjacent lens groups are varied; at a predetermined object distance the variable magnification optical system has a plurality of focused states with different amounts of aberration; the rear group includes a focusing lens group that moves at focusing, and a variable aberration lens group that differs from the focusing lens group and that moves at the predetermined object distance at transition from a first focused state to a second focused state, the first and second focused states being among the plurality of focused states and having different amounts of aberration.

The variable magnification optical system of the present embodiment can reduce variations in aberrations other than spherical aberration appropriately at transition from the first focused state to the second focused state, by the rear group including the focusing lens group and the variable aberration lens group.

In the variable magnification optical system of the present embodiment, the variable aberration lens group is preferably disposed between an aperture stop and an image plane.

The variable magnification optical system of the present embodiment can reduce variations in aberrations other than spherical aberration appropriately at transition from the first focused state to the second focused state, by the variable aberration lens group being disposed between an aperture stop and an image plane.

In the variable magnification optical system of the present embodiment, at least one of the focusing lens group and the variable aberration lens group preferably includes at least one lens Z satisfying the following conditional expressions:

$$n d L Z + ( 0.014 \; 25 \times vdLZ ) < 2.25 \qquad ( 10 )$$

$$vdLZ < 35 \text{.00} \qquad ( 11 )$$

$$0.702 < θ gFLZ + ( 0.003 \; 16 \times vdLZ ) \qquad ( 12 )$$

where
ndLZ: the refractive index of the lens Z at d-line
vdLZ: the Abbe number of the lens Z based on d-line
θgFLZ: the partial dispersion ratio of the lens Z defined by the following expression:

θgFLZ=(ngLZ−nFLZ)/(nFLZ−nCLZ)

where ngLZ, nFLZ, and nCLZ denote the refractive indices of the lens Z at g-line, F-line, and C-line, respectively.

The variable magnification optical system of the present embodiment can correct aberrations, including chromatic aberration, appropriately by at least one of the focusing lens group and the variable aberration lens group including at least one lens Z.

In the variable magnification optical system of the present embodiment, the focusing lens group and the variable aberration lens group are preferably composed of a lens satisfying the following conditional expression.

$$1.49 < n d F D C < 1.95 \qquad ( 15 )$$

where
ndFDC: the refractive index at d-line of each lens included in the focusing lens group and the variable aberration lens group

The variable magnification optical system of the present embodiment can prevent optical performance from being low, by the focusing lens group or the variable aberration lens group including at least one lens satisfying conditional expression (15).

The use of a lens that makes the value of conditional expression (15) greater than the upper limit in the focusing lens group or the variable aberration lens group results in the lens being sensitive, so that manufacturing errors are likely to cause low optical performance.

In the variable magnification optical system of the present embodiment, the effect of the present embodiment can be ensured by setting the upper limit of conditional expression (15) to 1.95. To further ensure the effect of the present embodiment, the upper limit of conditional expression (15) is preferably set to 1.91, more preferably to 1.88.

The use of a lens that makes the value of conditional expression (15) less than the lower limit in the focusing lens group or the variable aberration lens group requires the curvature of the lens to be increased. This causes higher-order aberration and low optical performance.

In the variable magnification optical system of the present embodiment, the effect of the present embodiment can be ensured by setting the lower limit of conditional expression (15) to 1.49. To further ensure the effect of the present embodiment, the lower limit of conditional expression (15) is preferably set to 1.55, more preferably to 1.58.

The variable magnification optical system of the present embodiment preferably satisfies the following conditional expression.

$$- 2.5 < f 1 / fW \text{<-} 1. \qquad ( 16 )$$

where
f1: the focal length of the first lens group
fW: the focal length of the variable magnification optical system in the wide-angle end state

Conditional expression (16) restricts the ratio between the focal lengths of the first lens group and the variable magnification optical system in the wide-angle end state. The variable magnification optical system of the present embodiment, which satisfies conditional expression (16), can be downsized, together with the first lens group, and correct aberrations appropriately.

If the value of conditional expression (16) is greater than the upper limit in the variable magnification optical system of the present embodiment, the first lens group will be upsized.

In the variable magnification optical system of the present embodiment, the effect of the present embodiment can be ensured by setting the upper limit of conditional expression (16) to −1.00. To further ensure the effect of the present embodiment, the upper limit of conditional expression (16) is preferably set to −1.20, −1.38, −1.58, or −1.75, more preferably to −1.95.

If the value of conditional expression (16) is less than the lower limit in the variable magnification optical system of the present embodiment, the first lens group will have too weak refractive power, making it difficult to correct aberrations appropriately. Further, the variable magnification optical system will be increased in total length and upsized.

In the variable magnification optical system of the present embodiment, the effect of the present embodiment can be ensured by setting the lower limit of conditional expression (16) to −2.50. To further ensure the effect of the present embodiment, the lower limit of conditional expression (16) is preferably set to −2.45, −2.40, or −2.35, more preferably to −2.30.

The variable magnification optical system of the present embodiment preferably satisfies the following conditional expression.

$$1. < f 1 / fW < 4. \qquad ( 17 )$$

where
f1: the focal length of the first lens group
fW: the focal length of the variable magnification optical system in the wide-angle end state

Conditional expression (17) restricts the ratio between the focal lengths of the first lens group and the variable magnification optical system in the wide-angle end state. The variable magnification optical system of the present embodiment, which satisfies conditional expression (17), can be downsized and correct aberrations appropriately.

If the value of conditional expression (17) is greater than the upper limit in the variable magnification optical system of the present embodiment, the first lens group will have too weak refractive power, making it difficult to correct aberrations appropriately. Further, the variable magnification optical system will be increased in total length and upsized.

In the variable magnification optical system of the present embodiment, the effect of the present embodiment can be ensured by setting the upper limit of conditional expression (17) to 4.00. To further ensure the effect of the present embodiment, the upper limit of conditional expression (17) is preferably set to 3.90, 3.85, 3.75, or 3.70, more preferably to 3.60.

If the value of conditional expression (17) is less than the lower limit in the variable magnification optical system of the present embodiment, the first lens group will have too strong refractive power, making it difficult to correct aberrations, including coma aberration, appropriately.

In the variable magnification optical system of the present embodiment, the effect of the present embodiment can be ensured by setting the lower limit of conditional expression (17) to 1.00. To further ensure the effect of the present embodiment, the lower limit of conditional expression (17) is preferably set to 1.03, 1.06, 1.08, or 1.11, more preferably to 1.14.

The variable magnification optical system of the present embodiment preferably satisfies the following conditional expression.

$$0.10 < Y / fW < 1. \qquad ( 18 )$$

where
Y: image height
fW: the focal length of the variable magnification optical system in the wide-angle end state

Conditional expression (18) restricts the ratio of image height to the focal length of the variable magnification optical system in the wide-angle end state. The variable magnification optical system of the present embodiment, which satisfies conditional expression (18), can be downsized.

If the value of conditional expression (18) is greater than the upper limit in the variable magnification optical system of the present embodiment, the lens diameter will be increased, which results in the variable magnification optical system being upsized.

In the variable magnification optical system of the present embodiment, the effect of the present embodiment can be ensured by setting the upper limit of conditional expression (18) to 1.00. To further ensure the effect of the present embodiment, the upper limit of conditional expression (18) is preferably set to 0.98, 0.96, 0.94, or 0.92, more preferably to 0.90.

If the value of conditional expression (18) is less than the lower limit in the variable magnification optical system of the present embodiment, the variable magnification optical system will be increased in total length and upsized.

In the variable magnification optical system of the present embodiment, the effect of the present embodiment can be ensured by setting the lower limit of conditional expression (18) to 0.10. To further ensure the effect of the present embodiment, the lower limit of conditional expression (18) is preferably set to 0.15 or 0.20, more preferably to 0.25.

The variable magnification optical system of the present embodiment preferably satisfies the following conditional expression.

$$1.5 < fW / BfW < 7.00 \qquad ( 19 )$$

where
BfW: the back focal length of the variable magnification optical system in the wide-angle end state
fW: the focal length of the variable magnification optical system in the wide-angle end state

Conditional expression (19) restricts the ratio of the back focal length to the focal length of the variable magnification optical system in the wide-angle end state. The variable magnification optical system of the present embodiment, which satisfies conditional expression (19), can be downsized and correct aberrations appropriately.

If the value of conditional expression (19) is greater than the upper limit in the variable magnification optical system of the present embodiment, the variable magnification optical system will be increased in total length and upsized.

In the variable magnification optical system of the present embodiment, the effect of the present embodiment can be ensured by setting the upper limit of conditional expression (19) to 7.00. To further ensure the effect of the present embodiment, the upper limit of conditional expression (19) is preferably set to 6.92, 6.84, 6.76, or 6.68, more preferably to 6.60.

If the value of conditional expression (19) is less than the lower limit in the variable magnification optical system of the present embodiment, the lens groups will have strong refractive power, making it difficult to correct aberrations, including coma aberration and curvature of field, appropriately.

In the variable magnification optical system of the present embodiment, the effect of the present embodiment can be ensured by setting the lower limit of conditional expression (19) to 1.50. To further ensure the effect of the present embodiment, the lower limit of conditional expression (19) is preferably set to 1.53, 1.57, 1.60, or 1.64, more preferably to 1.67.

The above configuration enables achieving a small-sized variable magnification optical system that can change from a first focused state to a second focused state at a predetermined object distance and that has favorable imaging performance.

An optical device of the present embodiment includes a variable magnification optical system configured as described above. This enables achieving a small-sized optical device that can change from a first focused state to a second focused state at a predetermined object distance and that has favorable imaging performance.

A first method for manufacturing a variable magnification optical system of the present embodiment is a method for manufacturing a variable magnification optical system comprising a first lens group, a second lens group, a third lens group, and a rear group in order from an object side. The method includes configuring the lens groups so that at varying magnification the distances between adjacent lens groups are varied; at a predetermined object distance the variable magnification optical system has a plurality of focused states with different amounts of aberration; the rear group includes a first focusing lens group and a second focusing lens group disposed closer to an image side than the first focusing lens group, the first and second focusing lens groups moving along different trajectories at focusing; at the predetermined object distance the first and second focusing lens groups move at transition from a first focused state to a second focused state, the first and second focused states being among the plurality of focused states and having different amounts of aberration; and the following conditional expression is satisfied.

$$- 6.8 < f 1 / f 2 \text{<-} 0.05 \qquad ( 1 )$$

where
f1: the focal length of the first lens group
f2: the focal length of the second lens group

A second method for manufacturing a variable magnification optical system of the present embodiment is a method for manufacturing a variable magnification optical system comprising a first lens group, a second lens group, a third lens group, and a rear group in order from an object side. The method includes configuring the lens groups so that at varying magnification the distances between adjacent lens groups are varied; at a predetermined object distance the variable magnification optical system has a plurality of focused states with different amounts of aberration; and the rear group includes a focusing lens group that moves at focusing, and a variable aberration lens group that differs from the focusing lens group and that moves at the predetermined object distance at transition from a first focused state to a second focused state, the first and second focused states being among the plurality of focused states and having different amounts of aberration.

Such methods for manufacturing a variable magnification optical system enable manufacturing a variable magnification optical system that can change from a first focused state to a second focused state at a predetermined object distance and that has favorable imaging performance.

### Numerical Examples

Examples of the present application will be described below with reference to the drawings.

### First Example

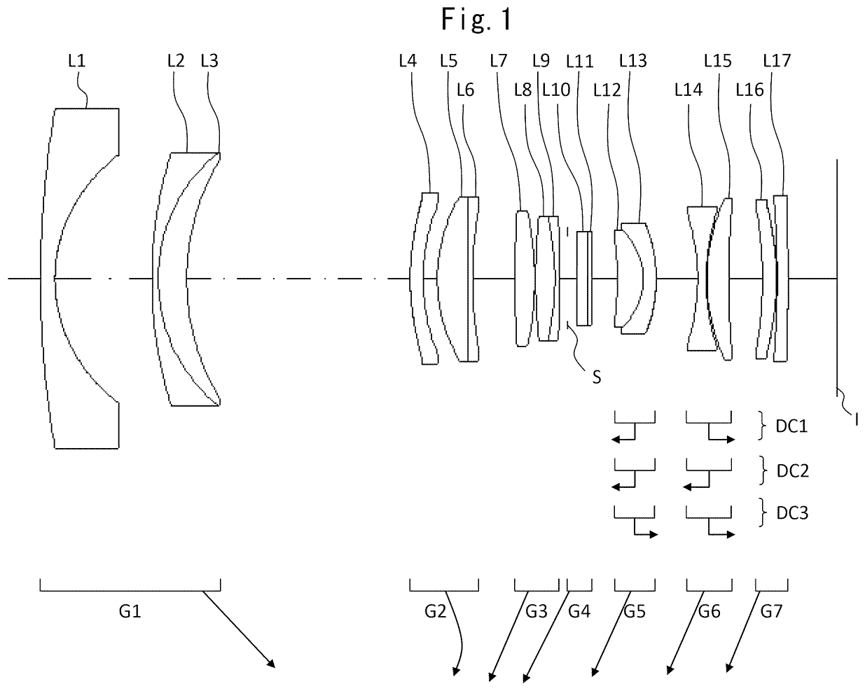

FIG. 1 is a cross-sectional view of a variable magnification optical system of a first example at focusing on an object at infinity in the wide-angle end state.

The variable magnification optical system of the present example includes, in order from the object side, a first lens group G1 having negative refractive power, second, third, fourth, and fifth lens groups G2, G3, G4, and G5 having positive refractive power, a sixth lens group G6 having negative refractive power, and a seventh lens group G7 having positive refractive power.

The first lens group G1 consists of, in order from the object side, a meniscus-shaped negative lens L1 convex on the object side and a positive cemented lens composed of a meniscus-shaped negative lens L2 convex on the object side and a meniscus-shaped positive lens L3 convex on the object side.

The second lens group G2 consists of, in order from the object side, a meniscus-shaped negative lens L4 convex on the object side and a positive cemented lens composed of a biconvex positive lens L5 and a biconcave negative lens L6.

The third lens group G3 consists of, in order from the object side, a biconvex positive lens L7 and a positive cemented lens composed of a biconvex positive lens L8 and a meniscus-shaped negative lens L9 concave on the object side.

The fourth lens group G4 consists of, in order from the object side, an aperture stop S and a positive cemented lens composed of a biconvex positive lens L10 and a biconcave negative lens L11.

The fifth lens group G5 consists of a positive cemented lens composed of a meniscus-shaped positive lens L12 concave on the object side and a meniscus-shaped negative lens L13 concave on the object side.

The sixth lens group G6 consists of, in order from the object side, a biconcave negative lens L14 and a meniscus-shaped positive lens L15 convex on the object side.

The seventh lens group G7 consists of, in order from the object side, meniscus-shaped positive lenses L16 and L17 concave on the object side.

An imaging device (not shown) constructed from CCD, CMOS, or the like is disposed on an image plane I.

The variable magnification optical system of the present example focuses by moving the fifth and sixth lens groups G5 and G6 along the optical axis. When focus is shifted from infinity to a nearby object, the fifth lens group G5 moves from the image plane side toward the object side whereas the sixth lens group G6 moves from the object side toward the image plane side.

The variable magnification optical system of the present example can change a focused state at a predetermined object distance from a first focused state to a second focused state by moving the fifth and sixth lens groups G5 and G6 along the optical axis from the image plane side toward the object side or vice versa.

In the variable magnification optical system of the present example, the fourth, fifth, sixth, and seventh lens groups G4, G5, G6, and G7 correspond to the rear group. The fifth and sixth lens groups G5 and G6 correspond to the first and second focusing lens groups, respectively.

Table 1 below shows specifications of the variable magnification optical system of the present example.

In [General specifications] of Table 1, TLW is the total optical length of the variable magnification optical system at focusing on an object at infinity in the wide-angle end state; TLT is the total optical length of the variable magnification optical system at focusing on an object at infinity in the telephoto end state. fW is the focal length of the variable magnification optical system in the wide-angle end state; fT is the focal length of the variable magnification optical system in the telephoto end state. FnoW is the f-number of the variable magnification optical system in the wide-angle end state; FnoT is the f-number of the variable magnification optical system in the telephoto end state; Y is image height; 2ωW is the total field angle of the variable magnification optical system in the wide-angle end state; 2ωT is the total field angle of the variable magnification optical system in the telephoto end state.

In [Lens specifications] of Table 1, m denotes the numbers of optical surfaces counted from the object side, r the radii of curvature, d the surface-to-surface distances, nd the refractive indices at d-line (wavelength 587.6 nm), and νd the Abbe numbers based on d-line. The radius of curvature r=∞ means a plane. In [Lens specifications], the optical surfaces with “*” are aspherical surfaces. [Lens specifications] also shows lenses corresponding to the lens Z of conditional expressions (10), (11), and (12), the lens F of conditional expression (13), and the lens FDC of conditional expressions (15).

In [Aspherical surface data] of Table 1, m denotes the optical surfaces corresponding to aspherical surface data, K the conic constants, and A4 to A12 the aspherical coefficients.

The aspherical surfaces are expressed by expression (a) below, where y denotes the height in a direction perpendicular to the optical axis, S(y) the distance along the optical axis from the tangent plane at the vertex of an aspherical surface to the aspherical surface at height y (a sag), r the radius of curvature of a reference sphere (paraxial radius of curvature), K the conic constant, and An the nth-order aspherical coefficient. In the examples, the second-order aspherical coefficient A2 is 0. “E−n” means “×10⁻ⁿ.”

$$( a ) S ( y ) = ( {y}^{2} / r ) / \{ 1 + {( 1 - K \times {y}^{2} / {r}^{2} )}^{1 / 2} \} + A 4 \times {y}^{4} + A 6 \times {y}^{6} + A 8 \times {y}^{8} + A 10 \times {y}^{10} + A 12 \times {y}^{12} + A 14 \times {y}^{14}$$

The unit of the focal lengths fW and fT, the radii of curvature r, and the other lengths listed in Table 1 is “mm.” However, the unit is not limited thereto because the optical performance of a proportionally enlarged or reduced variable magnification optical system is the same as that of the original optical system.

The above reference symbols in Table 1 will also be used similarly in the tables of the other examples described below.

TABLE 1
[General specifications]

| | |
|---|---|
| TLW | 190.00 |
| TLT | 160.00 |
| fW | 24.06 |
| fT | 50.15 |
| FNoW | 2.80 |
| FNoT | 3.81 |
| Y | 21.60 |
| 2ωW | 96.26 |
| 2ωT | 44.29 |

[Lens specifications]

| m | r | d | nd | νd | |
|---|---|---|---|---|---|
| 1) | 217.722 | 3.322 | 1.816000 | 46.59 | |
| *2) | 32.544 | 22.488 | | | |
| 3) | 92.013 | 1.500 | 1.487490 | 70.31 | |
| 4) | 36.365 | 6.583 | 2.000600 | 25.46 | |
| 5) | 50.858 | D5 | | | |
| *6) | 55.026 | 3.000 | 1.821299 | 42.72 | |
| 7) | 43.751 | 3.280 | | | |
| 8) | 35.764 | 7.168 | 1.691000 | 54.93 | |
| 9) | −1277.616 | 1.000 | 1.595509 | 39.24 | |
| 10) | 90.417 | D10 | | | |
| 11) | 231.974 | 4.573 | 1.880000 | 41.00 | |
| 12) | −70.324 | 0.200 | | | |
| 13) | 133.738 | 4.445 | 1.593190 | 67.90 | |
| 14) | −63.365 | 1.000 | 1.883603 | 20.66 | |
| 15) | −835.249 | D15 | | | |
| 16> | ∞ | 2.000 | | (aperture stop) | |
| 17) | 1314.631 | 2.653 | 1.945945 | 17.98 | |
| 18) | −419.873 | 1.000 | 1.737999 | 32.26 | |
| 19) | 11823.597 | D19 | | | |
| 20) | −68.484 | 5.996 | 1.593190 | 67.90 | |
| 21) | −14.603 | 3.000 | 1.767798 | 44.65 | (F) |
| *22) | −33.051 | D22 | | | |
| 23) | −47.759 | 2.000 | 1.712435 | 25.87 | (F) |
| 24) | 48.391 | 0.200 | | | |
| 25) | 41.866 | 5.000 | 1.951722 | 23.27 | (F) |
| 26) | 175.493 | D26 | | | |
| 27) | −87.637 | 3.187 | 1.927786 | 20.73 | |
| *28) | −60.073 | 0.200 | | | |
| 29) | −209.911 | 2.594 | 1.851348 | 40.10 | |
| *30) | −148.155 | D30 | | | |

[Aspherical surface data]

| m | K | A4 | A6 | A8 | A10 | A12 |
|---|---|---|---|---|---|---|
| 2) | 0.0000 | −8.10E−07 | 9.90E−10 | −6.63E−12 | 9.93E−15 | −6.98E−18 |
| 6) | 0.0000 | −2.60E−06 | −3.04E−09 | 4.62E−12 | −2.03E−14 | 2.00E−17 |
| 22) | 0.0000 | −1.61E−07 | −3.61E−08 | 2.37E−10 | −8.08E−13 | |
| 28) | 0.0000 | 5.24E−06 | −2.05E−08 | 2.90E−11 | 2.79E−14 | |
| 30) | 0.0000 | 0.00E+00 | 5.11E−08 | −1.86E−10 | 4.96E−13 | −6.00E−16 |

[Focal length data of groups]

| Groups | Starting surfaces | Focal lengths |
|---|---|---|
| G1 | 1 | −47.27 |
| G2 | 6 | 102.26 |
| G3 | 11 | 57.85 |
| G4 | 16 | 849.34 |
| G5 | 20 | 265.02 |
| G6 | 23 | −80.86 |
| G7 | 27 | 144.76 |

[Variable distance data]
< Wide-angle end >< Telephoto end >
<Infinity>< Close range ><Infinity>< Close range >

| | First focus | | Second focus | | Third focus | | First focus | | Second focus | Third focus |
|---|---|---|---|---|---|---|---|---|---|---|
| D5 | 51.82 | 51.82 | 51.82 | 51.82 | 4.56 | 4.56 | 4.56 | 4.56 | | |
| D10 | 9.84 | 9.84 | 9.84 | 9.84 | 0.92 | 0.92 | 0.92 | 0.92 | | |
| D15 | 2.00 | 2.00 | 2.00 | 2.00 | 4.59 | 4.59 | 4.59 | 4.59 | | |
| D19 | 5.84 | 3.25 | 5.84 | 5.84 | 6.86 | 4.45 | 6.86 | 6.86 | | |
| D22 | 9.60 | 17.63 | 16.49 | 1.38 | 11.31 | 20.51 | 11.95 | 3.77 | | |
| D26 | 7.87 | 2.46 | 0.20 | 12.92 | 9.34 | 2.55 | 7.64 | 13.43 | | |
| D30 | 11.30 | 11.30 | 16.04 | 18.48 | 27.93 | 27.93 | 17.35 | 19.76 | | |

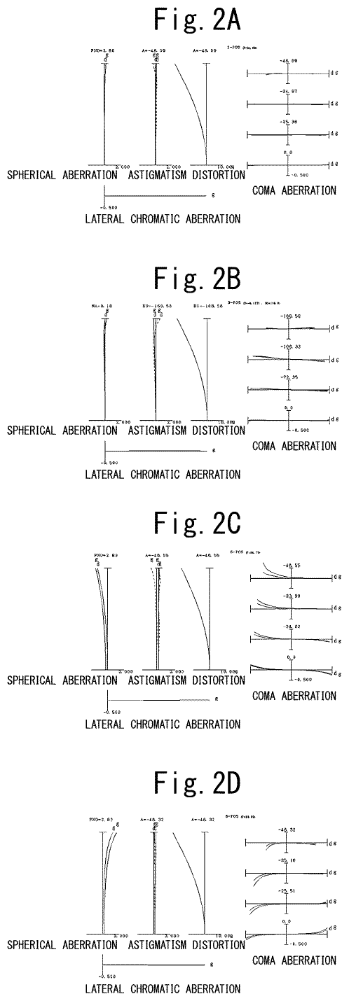

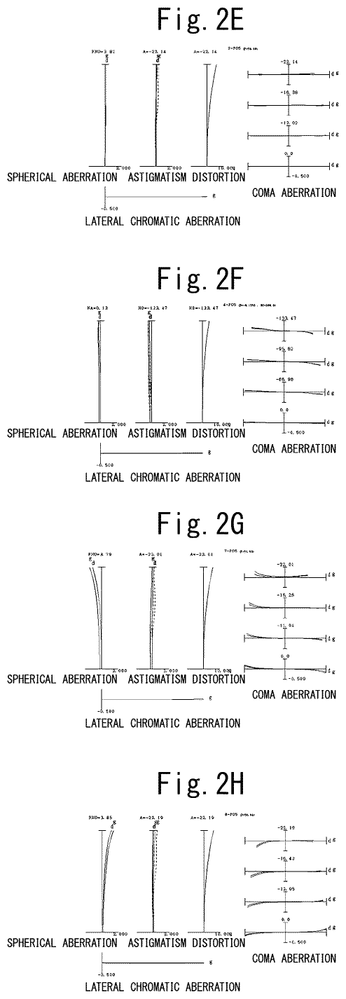

FIG. 2A shows aberrations of the variable magnification optical system of the first example at focusing on an object at infinity in the wide-angle end state; FIGS. 2B, 2C, and 2D show aberrations of the variable magnification optical system of the first example at first focusing, second focusing, and third focusing on a nearby object in the wide-angle end state, respectively; FIG. 2E shows aberrations of the variable magnification optical system of the first example at focusing on an object at infinity in the telephoto end state; FIGS. 2F, 2G, and 2H show aberrations of the variable magnification optical system of the first example at first focusing, second focusing, and third focusing on a nearby object in the telephoto end state, respectively.

In the graphs of aberrations, FNO and Y denote f-number and image height, respectively. More specifically, the graph of spherical aberration shows the f-number corresponding to the maximum aperture, the graphs of astigmatism and distortion show the maximum of image height, and the graphs of coma aberration show the values of image height. d and g denote d-line and g-line (wavelength 435.8 nm), respectively. In the graph of astigmatism, the solid lines and the broken lines show a sagittal plane and a meridional plane, respectively. The reference symbols in the graphs of aberrations of the present example will also be used in those of the other examples described below.

The graphs of aberrations suggest that the variable magnification optical system of the present example effectively reduces variations in aberrations at focusing and at varying magnification and has high optical performance.

### Second Example

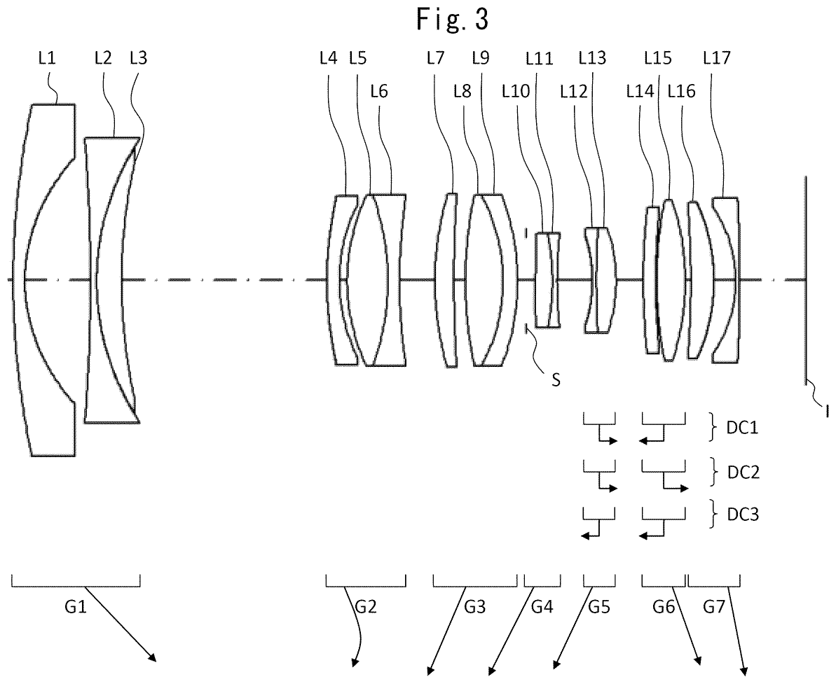

FIG. 3 is a cross-sectional view of a variable magnification optical system of a second example at focusing on an object at infinity in the wide-angle end state.

The variable magnification optical system of the present example includes, in order from the object side, a first lens group G1 having negative refractive power, second and third lens groups G2 and G3 having positive refractive power, fourth and fifth lens groups G4 and G5 having negative refractive power, a sixth lens group G6 having positive refractive power, and a seventh lens group G7 having negative refractive power.

The first lens group G1 consists of, in order from the object side, a meniscus-shaped negative lens L1 convex on the object side and a positive cemented lens composed of a biconcave negative lens L2 and a meniscus-shaped positive lens L3 convex on the object side.

The second lens group G2 consists of, in order from the object side, a meniscus-shaped negative lens L4 convex on the object side and a positive cemented lens composed of a biconvex positive lens L5 and a biconcave negative lens L6.

The third lens group G3 consists of, in order from the object side, a meniscus-shaped positive lens L7 convex on the object side and a positive cemented lens composed of a biconvex positive lens L8 and a meniscus-shaped negative lens L9 concave on the object side.

The fourth lens group G4 consists of, in order from the object side, an aperture stop S and a negative cemented lens composed of a biconvex positive lens L10 and a biconcave negative lens L11.

The fifth lens group G5 consists of a negative cemented lens composed of a biconcave negative lens L12 and a biconvex positive lens L13.

The sixth lens group G6 consists of, in order from the object side, a meniscus-shaped positive lens L14 convex on the object side and a biconvex positive lens L15.

The seventh lens group G7 consists of, in order from the object side, a meniscus-shaped positive lens L16 concave on the object side and a meniscus-shaped negative lens L17 concave on the object side.

An imaging device (not shown) constructed from CCD, CMOS, or the like is disposed on an image plane I.

The variable magnification optical system of the present example focuses by moving the fifth and sixth lens groups G5 and G6 along the optical axis. When focus is shifted from infinity to a nearby object, the fifth lens group G5 moves from the object side toward the image plane side whereas the sixth lens group G6 moves from the image plane side toward the object side.

The variable magnification optical system of the present example can change a focused state at a predetermined object distance from a first focused state to a second focused state by moving the fifth and sixth lens groups G5 and G6 along the optical axis from the object side toward the image plane side or vice versa.

In the variable magnification optical system of the present example, the fourth, fifth, sixth, and seventh lens groups G4, G5, G6, and G7 correspond to the rear group. The fifth and sixth lens groups G5 and G6 correspond to the first and second focusing lens groups, respectively.

Table 2 below shows specifications of the variable magnification optical system of the present example.

TABLE 2
[General specifications]

| | |
|---|---|
| TLW | 190.00 |
| TLT | 159.03 |
| fW | 24.20 |
| fT | 50.74 |
| FNoW | 2.80 |
| FNoT | 3.19 |
| Y | 21.60 |
| 2ωW | 87.33 |
| 2ωT | 44.43 |

[Lens specifications]

| m | r | d | nd | νd | |
|---|---|---|---|---|---|
| 1) | 177.439 | 2.800 | 1.816000 | 46.59 | |
| *2) | 36.179 | 17.368 | | | |
| 3) | −381.455 | 1.500 | 1.487490 | 70.32 | |
| 4) | 55.318 | 6.000 | 2.000690 | 25.46 | |
| 5) | 124.642 | D5 | | | |
| *6) | 68.486 | 3.000 | 1.821300 | 42.72 | |
| 7) | 35.342 | 1.963 | | | |
| 8) | 40.600 | 10.376 | 1.691000 | 54.93 | |
| 9) | −51.288 | 2.800 | 1.595510 | 39.24 | |
| 10) | 108.846 | D10 | | | |
| 11) | 61.772 | 4.557 | 1.615110 | 58.83 | |
| 12) | 238.656 | 2.148 | | | |
| 13) | 93.704 | 8.388 | 1.593190 | 67.90 | |
| 14) | −38.423 | 4.102 | 1.921320 | 20.01 | |
| 15) | −49.826 | D15 | | | |
| 16> | ∞ | 3.122 | | (aperture stop) | |
| 17) | 373.705 | 3.884 | 1.945940 | 17.98 | |
| 18) | −53.352 | 1.000 | 1.738000 | 32.26 | |
| 19) | 88.277 | D19 | | | |
| *20) | −36.198 | 1.000 | 1.745580 | 25.55 | (F) |
| 21) | 93.015 | 5.652 | 1.593190 | 67.90 | |
| 22) | −43.188 | D22 | | | |
| 23) | 82.757 | 3.000 | 1.920000 | 20.00 | (F) |
| 24) | 107.104 | 0.200 | | | |
| 25) | 86.016 | 6.730 | 1.525480 | 74.06 | |
| 26) | −54.552 | D26 | | | |
| 27) | −193.626 | 5.264 | 1.497250 | 80.06 | |
| *28) | −38.985 | 4.935 | | | |
| 29) | −27.667 | 1.000 | 1.851350 | 40.10 | |
| *30) | −469.209 | D30 | | | |

[Aspherical surface data]

| m | K | A4 | A6 | A8 | A10 | A12 |
|---|---|---|---|---|---|---|
| 2) | 0.0000 | −1.30E−06 | 4.27E−10 | −3.78E−12 | 4.73E−15 | −2.50E−18 |
| 6) | 0.0000 | −2.04E−06 | 4.73E−10 | −7.01E−12 | 1.58E−14 | −1.67E−17 |
| 20) | 0.0000 | −4.64E−06 | −1.65E−08 | 1.71E−10 | −1.10E−12 | |
| 28) | 0.0000 | 3.26E−06 | −2.61E−09 | −1.86E−11 | 2.42E−14 | |
| 30) | 0.0000 | 0.00E+00 | −1.91E−08 | 1.04E−10 | −2.67E−13 | 2.75E−16 |

[Focal length data of groups]

| Groups | Starting surfaces | Focal lengths |
|---|---|---|
| G1 | 1 | −55.58 |
| G2 | 6 | 353.16 |
| G3 | 11 | 45.21 |
| G4 | 16 | −562.97 |
| G5 | 20 | −133.99 |
| G6 | 23 | 56.05 |
| G7 | 27 | −56.95 |

[Variable distance data]
< Wide-angle end >< Telephoto end >
<Infinity>< Close range ><Infinity>< Close range >

| | First focus | | Second focus | | Third focus | | First focus | | Second focus | Third focus |
|---|---|---|---|---|---|---|---|---|---|---|
| D5 | 48.86 | 48.86 | 48.86 | 48.86 | 0.20 | 19.86 | 0.20 | 0.20 | | |
| D10 | 7.62 | 7.62 | 7.62 | 7.62 | 0.92 | 5.96 | 0.92 | 0.92 | | |
| D15 | 2.09 | 2.09 | 2.09 | 2.09 | 13.14 | 4.13 | 13.14 | 13.14 | | |
| D19 | 8.00 | 5.85 | 15.84 | 2.91 | 7.42 | 6.02 | 11.89 | 3.83 | | |
| D22 | 6.43 | 4.89 | 0.20 | 9.67 | 18.41 | 9.37 | 14.58 | 20.78 | | |
| D26 | 1.80 | 5.50 | 0.20 | 3.65 | 5.99 | 8.26 | 5.34 | 7.21 | | |
| D30 | 14.43 | 15.77 | 11.92 | 15.33 | 13.14 | 16.81 | 11.12 | 14.00 | | |

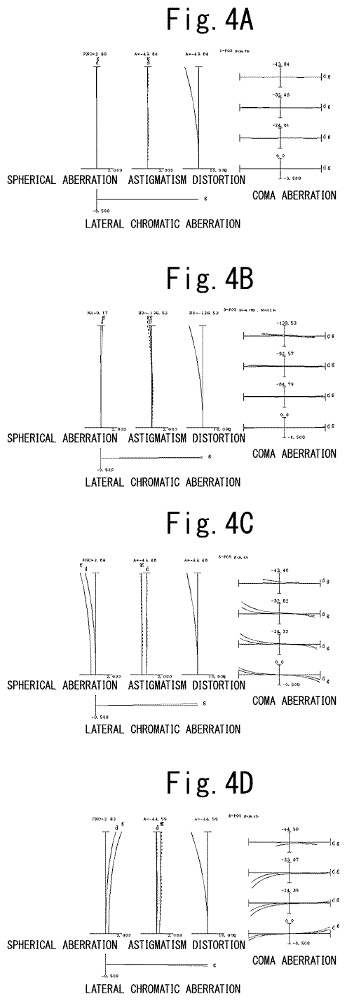

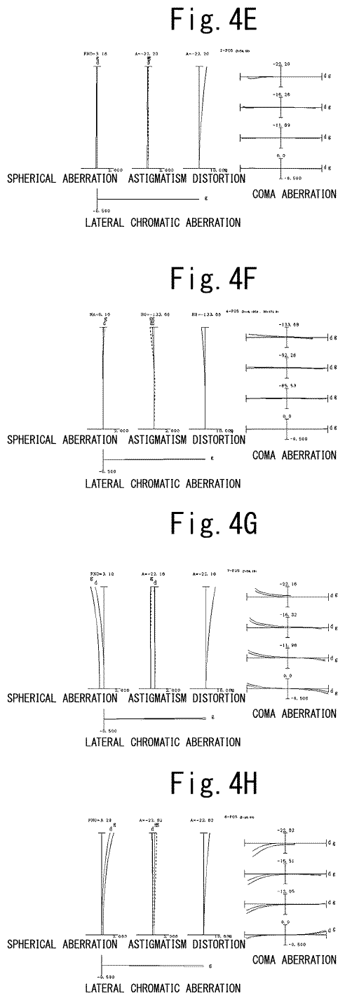

FIG. 4A shows aberrations of the variable magnification optical system of the second example at focusing on an object at infinity in the wide-angle end state; FIGS. 4B, 4C, and 4D show aberrations of the variable magnification optical system of the second example at first focusing, second focusing, and third focusing on a nearby object in the wide-angle end state, respectively; FIG. 4E shows aberrations of the variable magnification optical system of the second example at focusing on an object at infinity in the telephoto end state; FIGS. 4F, 4G, and 4H show aberrations of the variable magnification optical system of the second example at first focusing, second focusing, and third focusing on a nearby object in the telephoto end state, respectively.

The graphs of aberrations suggest that the variable magnification optical system of the present example effectively reduces variations in aberrations at focusing and at varying magnification and has high optical performance.

### Third Example

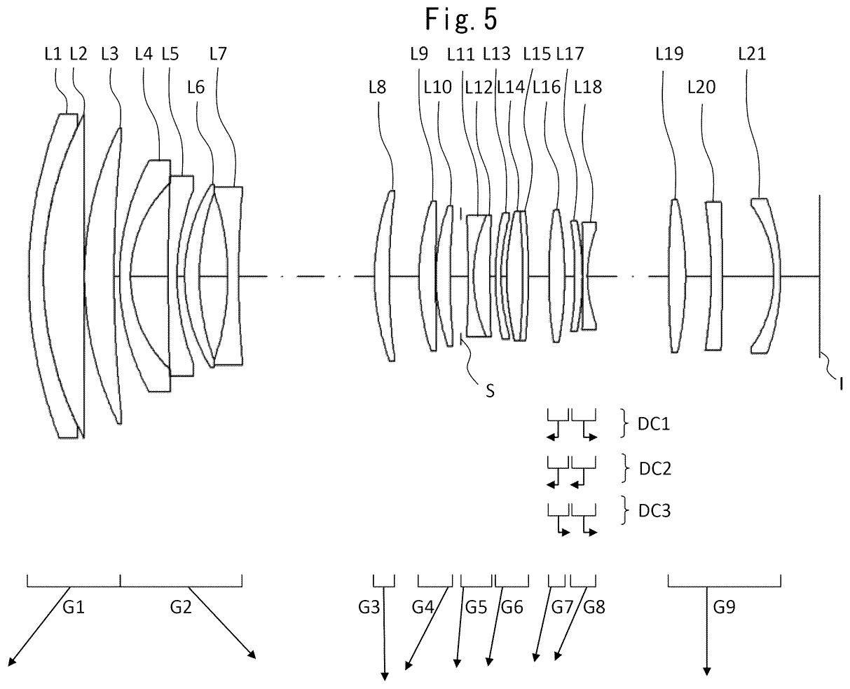

FIG. 5 is a cross-sectional view of a variable magnification optical system of a third example at focusing on an object at infinity in the wide-angle end state.

The variable magnification optical system of the present example includes, in order from the object side, a first lens group G1 having positive refractive power, a second lens group G2 having negative refractive power, third and fourth lens groups G3 and G4 having positive refractive power, a fifth lens group G5 having negative refractive power, sixth and seventh lens groups G6 and G7 having positive refractive power, an eighth lens group G8 having negative refractive power, and a ninth lens group G9 having positive refractive power.

The first lens group G1 consists of, in order from the object side, a positive cemented lens composed of a meniscus-shaped negative lens L1 convex on the object side and a planoconvex lens L2 convex on the object side, and a meniscus-shaped positive lens L3 convex on the object side.

The second lens group G2 consists of, in order from the object side, meniscus-shaped negative lenses L4 and L5 convex on the object side, a meniscus-shaped positive lens L6 convex on the object side, and a biconcave negative lens L7.

The third lens group G3 consists of a meniscus-shaped positive lens L8 convex on the object side.

The fourth lens group G4 consists of, in order from the object side, meniscus-shaped positive lenses L9 and L10 convex on the object side.

The fifth lens group G5 consists of an aperture stop S and a negative cemented lens composed of a biconcave negative lens L11 and a meniscus-shaped positive lens L12 convex on the object side.

The sixth lens group G6 consists of, in order from the object side, a meniscus-shaped negative lens L13 convex on the object side and a positive cemented lens composed of a biconvex positive lens L14 and a meniscus-shaped negative lens L15 concave on the object side.

The seventh lens group G7 consists of a biconvex positive lens L16.

The eighth lens group G8 consists of, in order from the object side, a meniscus-shaped positive lens L17 concave on the object side and a biconcave negative lens L18.

The ninth lens group G9 consists of, in order from the object side, a biconvex positive lens L19 and meniscus-shaped negative lenses L20 and L21 concave on the object side.

An imaging device (not shown) constructed from CCD, CMOS, or the like is disposed on an image plane I.

The variable magnification optical system of the present example focuses by moving the seventh and eighth lens groups G7 and G8 along the optical axis. When focus is shifted from infinity to a nearby object, the seventh lens group G7 moves from the image plane side toward the object side whereas the eighth lens group G8 moves from the object side toward the image plane side.

The variable magnification optical system of the present example can change a focused state at a predetermined object distance from a first focused state to a second focused state by moving the seventh and eighth lens groups G7 and G8 along the optical axis from the image plane side toward the object side or vice versa.

In the variable magnification optical system of the present example, the fourth, fifth, sixth, seventh, eighth, and ninth lens groups G4, G5, G6, G7, G8, and G9 correspond to the rear group. The seventh and eighth lens groups G7 and G8 correspond to the first and second focusing lens groups, respectively.

Table 3 below shows specifications of the variable magnification optical system of the present example.

TABLE 3
[General specifications]

| | |
|---|---|
| TLW | 217.05 |
| TLT | 221.20 |
| fW | 70.50 |
| fT | 139.01 |
| FNoW | 2.80 |
| FNoT | 2.87 |
| Y | 21.60 |
| 2ωW | 33.13 |
| 2ωT | 16.96 |

[Lens specifications]

| m | r | d | nd | νd | |
|---|---|---|---|---|---|
| 1) | 110.028 | 4.000 | 2.001000 | 29.12 | |
| 2) | 85.424 | 11.141 | 1.497820 | 82.57 | |
| 3) | ∞ | 0.101 | | | |
| 4) | 84.069 | 8.090 | 1.433837 | 95.16 | |
| *5) | 313.832 | D5 | | | |
| 6) | 59.635 | 3.000 | 1.603000 | 65.44 | |
| 7) | 32.686 | 10.318 | | | |
| 8) | 743.306 | 2.437 | 1.497820 | 82.57 | |
| 9) | 59.735 | 2.073 | | | |
| 10) | 42.872 | 4.010 | 1.663819 | 27.35 | |
| 11) | 60.986 | 7.796 | | | |
| 12) | −64.039 | 3.001 | 1.497820 | 82.57 | |
| 13) | 254.341 | D13 | | | |
| 14) | 61.747 | 4.001 | 1.945950 | 17.98 | |
| 15) | 152.776 | D15 | | | |
| 16) | 59.607 | 4.541 | 1.497820 | 82.57 | |
| 17) | 882.730 | 0.100 | | | |
| 18) | 53.954 | 3.862 | 1.497820 | 82.57 | |
| 19) | 183.397 | D19 | | | |
| 20> | ∞ | 1.931 | (aperture stop) | | |
| 21) | −251.336 | 1.447 | 1.922860 | 20.88 | |
| 22) | 37.241 | 4.522 | 1.497820 | 82.57 | |
| 23) | 436.859 | D23 | | | |
| 24) | 73.591 | 1.514 | 1.850260 | 32.35 | |
| 25) | 54.300 | 1.551 | | | |
| *26) | 57.932 | 4.384 | 1.592010 | 66.89 | |
| 27) | −165.806 | 1.553 | 1.620040 | 36.40 | |
| 28) | −180.432 | D28 | | | |
| 29) | 118.634 | 4.354 | 1.801000 | 34.92 | (F) |
| *30) | −92.844 | D30 | | | |
| 31) | −90.178 | 2.044 | 1.945950 | 17.98 | (Z) (F) |
| *32) | −70.350 | 0.100 | | | |
| 33) | −605.985 | 1.296 | 1.713000 | 53.96 | (F) |
| 34) | 33.608 | D34 | | | |
| *35) | 333.382 | 4.568 | 1.902650 | 35.77 | |
| 36) | −87.639 | 7.037 | | | |
| *37) | −96.907 | 3.000 | 1.516120 | 63.84 | |
| 38) | −563.358 | 14.132 | | | |
| 39) | −30.231 | 1.822 | 1.563840 | 60.71 | |
| 40) | −54.559 | 10.700 | | | |

[Aspherical surface data]

| m | K | A4 | A6 | A8 | A10 | A12 |
|---|---|---|---|---|---|---|
| 5) | 0.0000 | −1.35E−08 | 6.90E−12 | −3.44E−15 | 6.15E−19 | |
| 26) | 0.0000 | −4.44E−06 | −1.79E−10 | −1.24E−11 | 2.82E−14 | −7.41E−18 |
| 30) | 0.0000 | 1.34E−07 | −2.24E−09 | −3.07E−12 | 1.39E−14 | |
| 32) | 0.0000 | 1.34E−07 | −2.24E−09 | −3.07E−12 | 1.39E−14 | |
| 35) | 0.0000 | 1.35E−06 | 1.36E−09 | −3.43E−12 | 1.11E−15 | |
| 37) | 0.0000 | 1.25E−06 | 3.51E−09 | −1.12E−11 | 4.67E−14 | −4.25E−17 |

[Focal length data of groups]

| Groups | Starting surfaces | Focal lengths |
|---|---|---|
| G1 | 1 | 142.99 |
| G2 | 6 | −43.85 |
| G3 | 14 | 107.26 |
| G4 | 16 | 70.12 |
| G5 | 20 | −61.31 |
| G6 | 24 | 106.28 |
| G7 | 29 | 65.62 |
| G8 | 31 | −51.29 |
| G9 | 35 | 371.91 |

[Variable distance data]

| | <Wide-angle end> | | | | <Telephoto end> | | | |
|---|---|---|---|---|---|---|---|---|
| | | <Close range> | | | | <Close range> | | |
| | <Infinity> | First focus | Second focus | Third focus | <Infinity> | First focus | Second focus | Third focus |
| D5 | 1.50 | 1.50 | 1.50 | 1.50 | 32.83 | 32.83 | 32.83 | 32.83 |
| D13 | 37.19 | 37.19 | 37.19 | 37.19 | 10.98 | 10.98 | 10.98 | 10.98 |
| D15 | 8.20 | 8.20 | 8.20 | 8.20 | 1.50 | 1.50 | 1.50 | 1.50 |
| D19 | 3.00 | 3.00 | 3.00 | 3.00 | 4.80 | 4.80 | 4.80 | 4.80 |
| D23 | 1.50 | 1.50 | 1.50 | 1.50 | 2.58 | 2.58 | 2.58 | 2.58 |
| D28 | 5.61 | 7.22 | 1.72 | 9.58 | 5.23 | 8.33 | 1.72 | 8.82 |
| D30 | 2.77 | 7.56 | 2.96 | 2.55 | 1.76 | 11.70 | 2.00 | 1.50 |
| D34 | 22.30 | 15.90 | 26.00 | 18.55 | 26.55 | 13.47 | 29.78 | 23.18 |

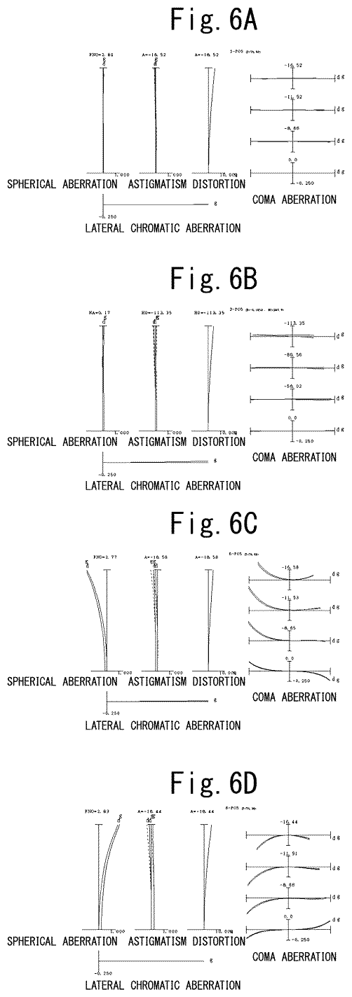

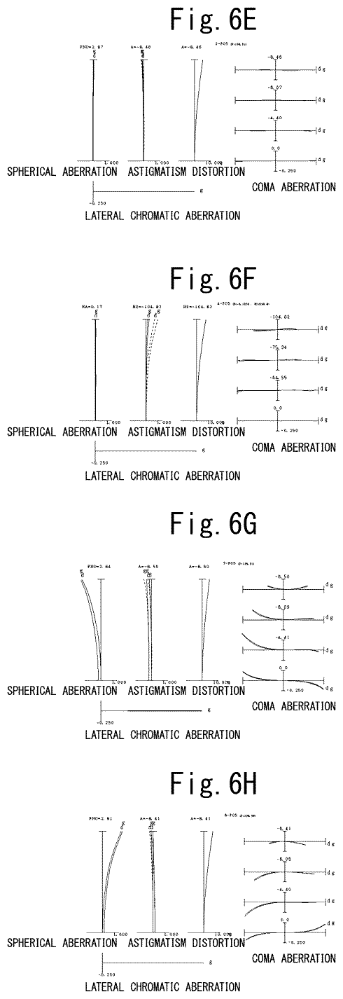

FIG. 6A shows aberrations of the variable magnification optical system of the third example at focusing on an object at infinity in the wide-angle end state; FIGS. 6B, 6C, and 6D show aberrations of the variable magnification optical system of the third example at first focusing, second focusing, and third focusing on a nearby object in the wide-angle end state, respectively; FIG. 6E shows aberrations of the variable magnification optical system of the third example at focusing on an object at infinity in the telephoto end state; FIGS. 6F, 6G, and 6H show aberrations of the variable magnification optical system of the third example at first focusing, second focusing, and third focusing on a nearby object in the telephoto end state, respectively.

The graphs of aberrations suggest that the variable magnification optical system of the present example effectively reduces variations in aberrations at focusing and at varying magnification and has high optical performance.

### Fourth Example

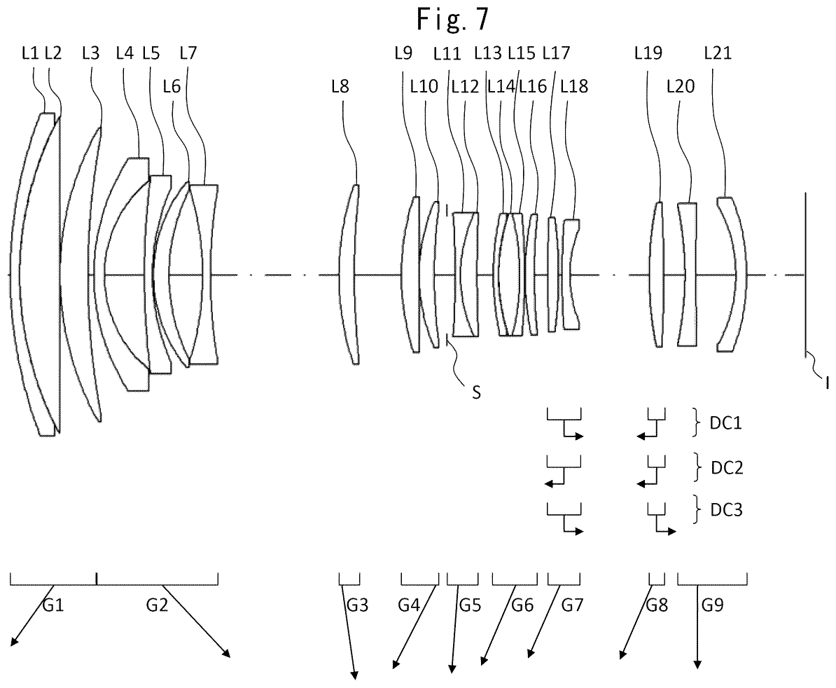

FIG. 7 is a cross-sectional view of a variable magnification optical system of a fourth example at focusing on an object at infinity in the wide-angle end state.

The variable magnification optical system of the present example includes, in order from the object side, a first lens group G1 having positive refractive power, a second lens group G2 having negative refractive power, third and fourth lens groups G3 and G4 having positive refractive power, a fifth lens group G5 having negative refractive power, a sixth lens group G6 having positive refractive power, a seventh lens group G7 having negative refractive power, an eighth lens group G8 having positive refractive power, and a ninth lens group G9 having negative refractive power.

The first lens group G1 consists of, in order from the object side, a positive cemented lens composed of a meniscus-shaped negative lens L1 convex on the object side and a planoconvex lens L2 convex on the object side, and a meniscus-shaped positive lens L3 convex on the object side.

The second lens group G2 consists of, in order from the object side, meniscus-shaped negative lenses L4 and L5 convex on the object side, a meniscus-shaped positive lens L6 convex on the object side, and a biconcave negative lens L7.

The third lens group G3 consists of a meniscus-shaped positive lens L8 convex on the object side.

The fourth lens group G4 consists of, in order from the object side, meniscus-shaped positive lenses L9 and L10 convex on the object side.

The fifth lens group G5 consists of, in order from the object side, an aperture stop S and a negative cemented lens composed of a biconcave negative lens L11 and a meniscus-shaped positive lens L12 convex on the object side.

The sixth lens group G6 consists of, in order from the object side, a meniscus-shaped negative lens L13 convex on the object side, a positive cemented lens composed of a biconvex positive lens L14 and a meniscus-shaped negative lens L15 concave on the object side, and a meniscus-shaped positive lens L16 convex on the object side.

The seventh lens group G7 consists of, in order from the object side, a biconvex positive lens L17 and a meniscus-shaped negative lens L18 convex on the object side.

The eighth lens group G8 consists of a biconvex positive lens L19.

The ninth lens group G9 consists of, in order from the object side, a biconcave negative lens L20 and a meniscus-shaped negative lens L21 concave on the object side.

An imaging device (not shown) constructed from CCD, CMOS, or the like is disposed on an image plane I.

The variable magnification optical system of the present example focuses by moving the seventh and eighth lens groups G7 and G8 along the optical axis. When focus is shifted from infinity to a nearby object, the seventh lens group G7 moves from the object side toward the image plane side whereas the eighth lens group G8 moves from the image plane side toward the object side.

The variable magnification optical system of the present example can change a focused state at a predetermined object distance from a first focused state to a second focused state by moving the seventh and eighth lens groups G7 and G8 along the optical axis from the image plane side toward the object side or vice versa.

In the variable magnification optical system of the present example, the fourth, fifth, sixth, seventh, eighth, and ninth lens groups G4, G5, G6, G7, G8, and G9 correspond to the rear group. The seventh and eighth lens groups G7 and G8 correspond to the first and second focusing lens groups, respectively.

Table 4 below shows specifications of the variable magnification optical system of the present example.

TABLE 4
[General specifications]

| | |
|---|---|
| TLW | 218.90 |
| TLT | 221.19 |
| fW | 70.86 |
| fT | 139.73 |
| FNoW | 2.80 |
| FNoT | 2.93 |
| Y | 21.60 |
| 2ωW | 33.59 |
| 2ωT | 17.26 |

[Lens specifications]

| m | r | d | nd | νd | |
|---|---|---|---|---|---|
| 1) | 110.788 | 2.597 | 2.001000 | 29.12 | |
| 2) | 84.006 | 11.122 | 1.497820 | 82.57 | |
| 3) | ∞ | 0.052 | | | |
| 4) | 74.624 | 7.683 | 1.433837 | 95.16 | |
| *5) | 183.809 | D5 | | | |
| 6) | 53.229 | 2.881 | 1.603000 | 65.44 | |
| 7) | 30.752 | 11.000 | | | |
| 8) | 201.222 | 2.191 | 1.497820 | 82.57 | |
| 9) | 53.191 | 0.265 | | | |
| 10) | 36.590 | 4.281 | 1.663819 | 27.35 | |
| 11) | 47.018 | 9.239 | | | |
| 12) | −70.512 | 2.163 | 1.497820 | 82.57 | |
| 13) | 130.180 | D13 | | | |
| 14) | 69.602 | 4.218 | 1.945950 | 17.98 | |
| 15) | 191.210 | D15 | | | |
| 16) | 63.122 | 4.796 | 1.497820 | 82.57 | |
| 17) | 2858.738 | 0.082 | | | |
| 18) | 45.868 | 4.180 | 1.497820 | 82.57 | |
| 19) | 127.127 | D19 | | | |
| 20> | ∞ | 2.265 | (aperture stop) | | |
| 21) | −239.980 | 1.478 | 1.922860 | 20.88 | |
| 22) | 36.586 | 4.569 | 1.497820 | 82.57 | |
| 23) | 410.192 | D23 | | | |
| 24) | 71.562 | 1.404 | 1.850260 | 32.35 | |
| 25) | 48.405 | 0.049 | | | |
| *26) | 45.673 | 5.771 | 1.592010 | 66.89 | |
| 27) | −60.756 | 1.370 | 1.620040 | 36.40 | |
| 28) | −163.685 | 0.118 | | | |
| 29) | 74.961 | 2.548 | 1.801000 | 34.92 | |
| *30) | 149.863 | D30 | | | |
| 31) | 382.295 | 2.961 | 1.945950 | 17.98 | (Z) (F) |
| *32) | −113.039 | 0.953 | | | |
| 33) | 177.759 | 2.168 | 1.713000 | 53.96 | (F) |
| 34) | 31.415 | D34 | | | |
| *35) | 97.645 | 3.984 | 1.902650 | 35.77 | (F) |
| 36) | −324.454 | D36 | | | |
| *37) | −78.659 | 3.006 | 1.516120 | 63.84 | |
| 38) | 780.001 | 10.956 | | | |
| 39) | −35.236 | 2.993 | 1.563840 | 60.71 | |
| 40) | −51.465 | 16.710 | | | |

[Aspherical surface data]

| m | K | A4 | A6 | A8 | A10 | A12 |
|---|---|---|---|---|---|---|
| 5) | 0.0000 | −2.52E−08 | 4.73E−13 | 7.68E−16 | −5.72E−19 | |
| 26) | 0.0000 | −2.61E−06 | 4.09E−10 | −1.53E−11 | 3.52E−14 | −2.52E−17 |
| 30) | 0.0000 | 1.59E−06 | −3.70E−10 | −4.63E−12 | 6.80E−15 | |
| 32) | 0.0000 | −6.62E−07 | −8.73E−10 | 1.55E−12 | −6.08E−15 | |
| 35) | 0.0000 | 1.22E−06 | 1.28E−09 | −3.45E−12 | 2.08E−15 | |
| 37) | 0.0000 | 3.73E−07 | 2.93E−09 | −7.61E−12 | 3.51E−14 | −3.69E−17 |

[Focal length data of groups]

| Groups | Starting surfaces | Focal lengths |
|---|---|---|
| G1 | 1 | 152.45 |
| G2 | 6 | −42.36 |
| G3 | 14 | 113.77 |
| G4 | 16 | 68.14 |
| G5 | 20 | −59.62 |
| G6 | 24 | 63.37 |
| G7 | 31 | −139.14 |
| G8 | 35 | 83.53 |
| G9 | 37 | −81.80 |

[Variable distance data]

| | <Wide-angle end> | | | | <Telephoto end> | | | |
|---|---|---|---|---|---|---|---|---|
| | | <Close range> | | | | <Close range> | | |
| | <Infinity> | First focus | Second focus | Third focus | <Infinity> | First focus | Second focus | Third focus |
| D5 | 1.61 | 1.61 | 1.61 | 1.61 | 33.32 | 33.32 | 33.32 | 33.32 |
| D13 | 35.26 | 35.26 | 35.26 | 35.26 | 11.25 | 11.25 | 11.25 | 11.25 |
| D15 | 12.91 | 12.91 | 12.91 | 12.91 | 3.29 | 3.29 | 3.29 | 3.29 |
| D19 | 3.43 | 3.43 | 3.43 | 3.43 | 6.07 | 6.07 | 6.07 | 6.07 |
| D23 | 4.47 | 4.47 | 4.47 | 4.47 | 1.50 | 1.50 | 1.50 | 1.50 |
| D30 | 3.68 | 6.86 | 2.39 | 5.08 | 3.35 | 9.99 | 1.97 | 4.71 |
| D34 | 21.79 | 9.99 | 22.00 | 21.67 | 26.78 | 3.25 | 27.18 | 26.75 |
| D36 | 5.81 | 14.44 | 6.90 | 4.55 | 5.68 | 22.58 | 6.80 | 4.42 |

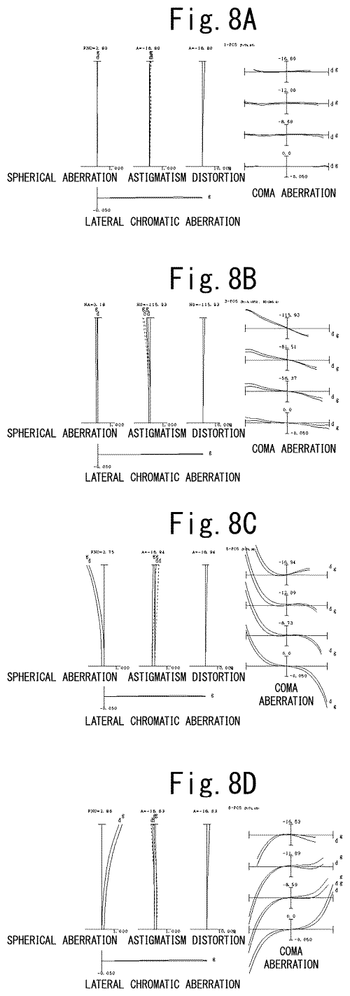

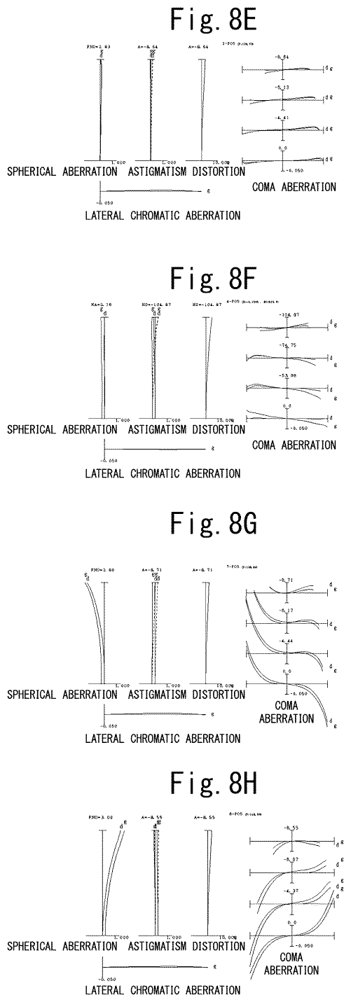

FIG. 8A shows aberrations of the variable magnification optical system of the fourth example at focusing on an object at infinity in the wide-angle end state; FIGS. 8B, 8C, and 8D show aberrations of the variable magnification optical system of the fourth example at first focusing, second focusing, and third focusing on a nearby object in the wide-angle end state, respectively; FIG. 8E shows aberrations of the variable magnification optical system of the fourth example at focusing on an object at infinity in the telephoto end state; FIGS. 8F, 8G, and 8H show aberrations of the variable magnification optical system of the fourth example at first focusing, second focusing, and third focusing on a nearby object in the telephoto end state, respectively.

The graphs of aberrations suggest that the variable magnification optical system of the present example effectively reduces variations in aberrations at focusing and at varying magnification and has high optical performance.

### Fifth Example

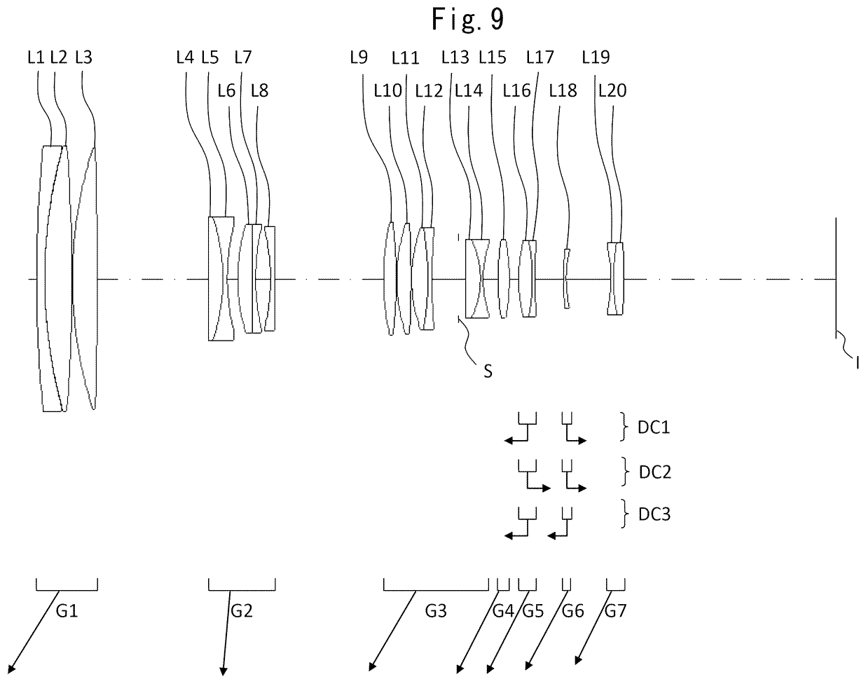

FIG. 9 is a cross-sectional view of a variable magnification optical system of a fifth example at focusing on an object at infinity in the wide-angle end state.

The variable magnification optical system of the present example includes, in order from the object side, a first lens group G1 having positive refractive power, a second lens group G2 having negative refractive power, third, fourth, and fifth lens groups G3, G4, and G5 having positive refractive power, and sixth and seventh lens groups G6 and G7 having negative refractive power.

The first lens group G1 consists of, in order from the object side, a positive cemented lens composed of a meniscus-shaped negative lens L1 convex on the object side and a biconvex positive lens L2, and a biconvex positive lens L3.

The second lens group G2 consists of, in order from the object side, a negative cemented lens composed of a biconvex positive lens L4 and a biconcave negative lens L5, a positive cemented lens composed of a meniscus-shaped positive lens L6 convex on the object side and a meniscus-shaped negative lens L7 convex on the object side, and a biconcave negative lens L8.

The third lens group G3 consists of, in order from the object side, biconvex positive lenses L9 and L10, a positive cemented lens composed of a biconvex positive lens L11 and a biconcave negative lens L12, an aperture stop S, and a negative cemented lens composed of a biconvex positive lens L13 and a biconcave negative lens L14.

The fourth lens group G4 consists of a biconvex positive lens L15.

The fifth lens group G5 consists of a positive cemented lens composed of a biconvex positive lens L16 and a biconcave negative lens L17.

The sixth lens group G6 consists of a meniscus-shaped negative lens L18 convex on the object side.

The seventh lens group G7 consists of a negative cemented lens composed of a biconcave negative lens L19 and a biconvex positive lens L20.

An imaging device (not shown) constructed from CCD, CMOS, or the like is disposed on an image plane I.

The variable magnification optical system of the present example focuses by moving the fifth and sixth lens groups G5 and G6 along the optical axis. When focus is shifted from infinity to a nearby object, the fifth lens group G5 moves from the image plane side toward the object side whereas the sixth lens group G6 moves from the object side toward the image plane side.

The variable magnification optical system of the present example can change a focused state at a predetermined object distance from a first focused state to a second focused state by moving the fifth and sixth lens groups G5 and G6 along the optical axis from the object side toward the image plane side or vice versa.

In the variable magnification optical system of the present example, the fourth, fifth, sixth, and seventh lens groups G4, G5, G6, and G7 correspond to the rear group. The fifth and sixth lens groups G5 and G6 correspond to the first and second focusing lens groups, respectively.

Table 5 below shows specifications of the variable magnification optical system of the present example.

TABLE 5
[General specifications]

| | |
|---|---|
| TLW | 296.15 |
| TLT | 370.80 |
| fW | 194.59 |
| fT | 570.46 |
| FNoW | 6.50 |
| FNoT | 6.90 |
| Y | 21.60 |
| 2ωW | 12.53 |
| 2ωT | 4.27 |

[Lens specifications]

| m | r | d | nd | νd | |
|---|---|---|---|---|---|
| 1) | 449.211 | 3.000 | 1.834000 | 37.35 | |
| 2) | 163.594 | 10.050 | 1.497000 | 81.61 | |
| 3) | −576.154 | 0.200 | | | |
| 4) | 142.446 | 9.100 | 1.497000 | 81.61 | |
| 5) | −1665.479 | D5 | | | |
| 6) | 1672.367 | 5.500 | 1.805180 | 25.45 | |
| 7) | −63.842 | 1.600 | 1.700000 | 48.11 | |
| 8) | 70.416 | 3.830 | | | |
| 9) | 60.407 | 5.248 | 1.846660 | 23.80 | |
| 10) | 544.044 | 1.400 | 1.804000 | 46.60 | |
| 11) | 75.451 | 5.502 | | | |
| 12) | −69.361 | 1.500 | 1.921190 | 23.96 | |
| 13) | 682.689 | D13 | | | |
| 14) | 86.673 | 4.700 | 1.497000 | 81.61 | |
| 15) | −151.927 | 0.200 | | | |
| 16) | 58.367 | 5.300 | 1.487490 | 70.44 | |
| 17) | −313.095 | 0.200 | | | |
| 18) | 50.061 | 6.000 | 1.487490 | 70.44 | |
| 19) | −99.135 | 1.500 | 1.903660 | 31.31 | |
| 20) | 198.605 | 10.000 | | | |
| 21> | ∞ | 2.356 | (aperture stop) | | |
| 22) | 4551.121 | 5.621 | 1.850260 | 32.35 | |
| 23) | −29.962 | 1.000 | 1.795000 | 45.31 | |
| 24) | 37.151 | 4.500 | | | |
| 25) | ∞ | D25 | (virtual plane) | | |
| 26) | ∞ | 0.000 | (virtual plane) | | |
| 27) | 76.878 | 4.200 | 1.531720 | 48.78 | |
| 28) | −76.926 | D28 | | | |
| 29) | 56.990 | 5.000 | 1.595510 | 39.21 | |
| 30) | −71.411 | 1.000 | 1.846660 | 23.80 | (F) |
| 31) | 207.092 | 0.000 | | | |
| 32) | ∞ | D32 | (virtual plane) | | |
| 33) | 91.583 | 1.000 | 1.729160 | 54.61 | (F) |
| 34) | 41.424 | D34 | | | |
| 35) | −50.321 | 1.000 | 1.603000 | 65.44 | |
| 36) | 65.813 | 4.000 | 1.698950 | 30.13 | |
| 37) | −118.348 | D37 | | | |

[Focal length data of groups]

| Groups | Starting surfaces | Focal lengths |
|---|---|---|
| G1 | 1 | 225.38 |
| G2 | 6 | −52.15 |
| G3 | 14 | 85.43 |
| G4 | 26 | 73.01 |
| G5 | 29 | 321.67 |
| G6 | 33 | −104.61 |
| G7 | 35 | −226.35 |

[Variable distance data]

| | <Wide-angle end> | | | | <Telephoto end> | | | |
|---|---|---|---|---|---|---|---|---|
| | | <Close range> | | | | <Close range> | | |
| | <Infinity> | First focus | Second focus | Third focus | <Infinity> | First focus | Second focus | Third focus |
| D5 | 41.08 | 41.08 | 41.08 | 41.08 | 113.28 | 113.28 | 113.28 | 113.28 |
| D13 | 40.32 | 40.32 | 40.32 | 40.32 | 1.47 | 1.47 | 1.47 | 1.47 |
| D25 | 0.90 | 0.90 | 0.90 | 0.90 | 28.86 | 28.86 | 28.86 | 28.86 |
| D28 | 3.55 | 2.29 | 8.57 | 0.20 | 3.11 | 0.62 | 6.43 | 0.28 |
| D32 | 10.51 | 20.39 | 8.84 | 11.76 | 2.43 | 21.56 | 0.76 | 3.77 |
| D34 | 16.52 | 7.91 | 13.18 | 18.62 | 22.12 | 5.48 | 20.48 | 23.61 |
| D37 | 78.21 | 78.21 | 78.21 | 78.21 | 93.43 | 93.43 | 93.43 | 93.43 |

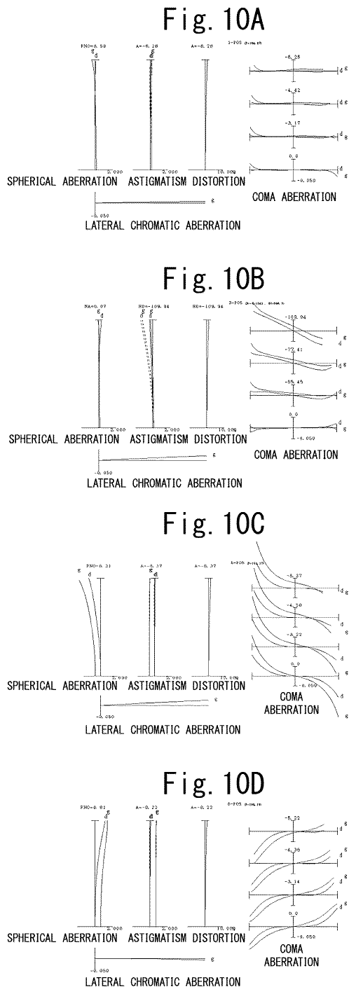

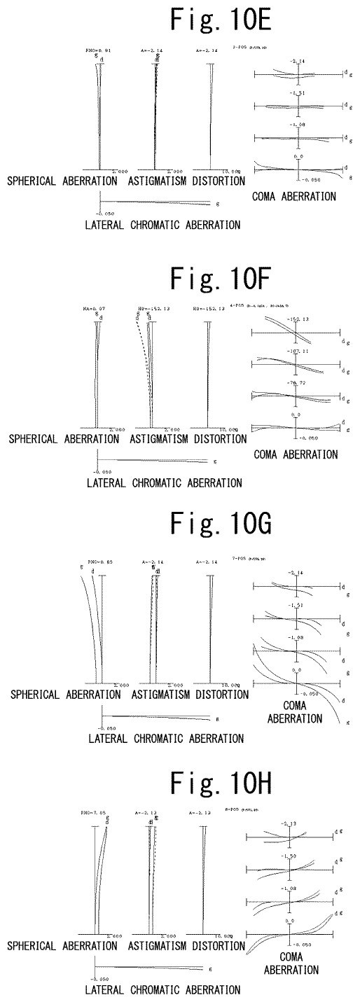

FIG. 10A shows aberrations of the variable magnification optical system of the fifth example at focusing on an object at infinity in the wide-angle end state; FIGS. 10B, 10C, and 10D show aberrations of the variable magnification optical system of the fifth example at first focusing, second focusing, and third focusing on a nearby object in the wide-angle end state, respectively; FIG. 10E shows aberrations of the variable magnification optical system of the fifth example at focusing on an object at infinity in the telephoto end state; FIGS. 10F, 10G, and 10H show aberrations of the variable magnification optical system of the fifth example at first focusing, second focusing, and third focusing on a nearby object in the telephoto end state, respectively.

The graphs of aberrations suggest that the variable magnification optical system of the present example effectively reduces variations in aberrations at focusing and at varying magnification and has high optical performance.

### Sixth Example

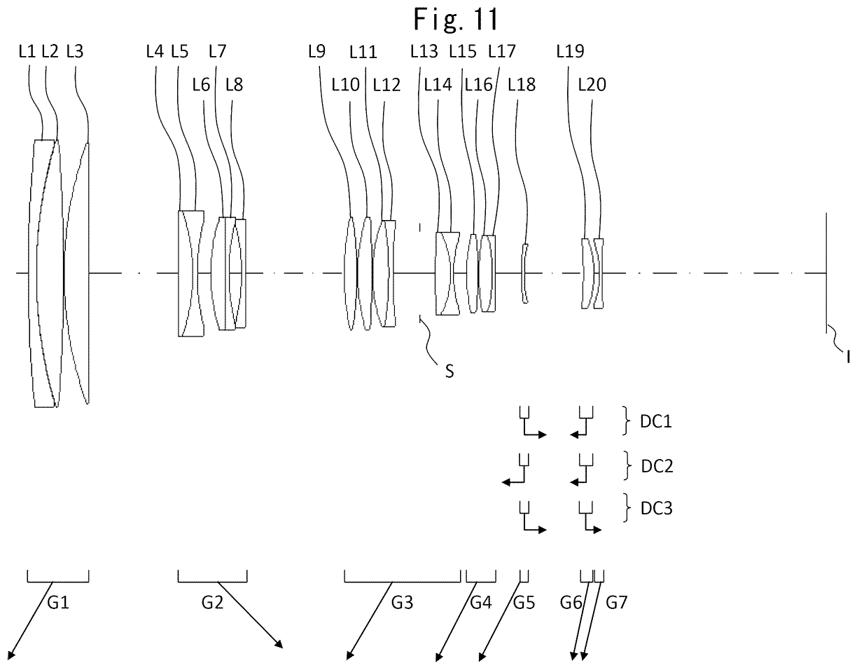

FIG. 11 is a cross-sectional view of a variable magnification optical system of a sixth example at focusing on an object at infinity in the wide-angle end state.

The variable magnification optical system of the present example includes, in order from the object side, a first lens group G1 having positive refractive power, a second lens group G2 having negative refractive power, third and fourth lens groups G3 and G4 having positive refractive power, a fifth lens group G5 having negative refractive power, a sixth lens group G6 having positive refractive power, and a seventh lens group G7 having negative refractive power.

The first lens group G1 consists of, in order from the object side, a positive cemented lens composed of a meniscus-shaped negative lens L1 convex on the object side and a biconvex positive lens L2, and a meniscus-shaped positive lens L3 convex on the object side.

The second lens group G2 consists of, in order from the object side, a negative cemented lens composed of a biconvex positive lens L4 and a biconcave negative lens L5, a positive cemented lens composed of a meniscus-shaped positive lens L6 convex on the object side and a meniscus-shaped negative lens L7 convex on the object side, and a biconcave negative lens L8.

The third lens group G3 consists of, in order from the object side, biconvex positive lenses L9 and L10, a positive cemented lens composed of a biconvex positive lens L11 and a biconcave negative lens L12, an aperture stop S, and a negative cemented lens composed of a biconvex positive lens L13 and a biconcave negative lens L14.

The fourth lens group G4 consists of, in order from the object side, a biconvex positive lens L15 and a positive cemented lens composed of a biconvex positive lens L16 and a meniscus-shaped negative lens L17 concave on the object side.

The fifth lens group G5 consists of a meniscus-shaped negative lens L18 convex on the object side.

The sixth lens group G6 consists of a meniscus-shaped positive lens L19 concave on the object side.

The seventh lens group G7 consists of a biconcave negative lens L20.

An imaging device (not shown) constructed from CCD, CMOS, or the like is disposed on an image plane I.

The variable magnification optical system of the present example focuses by moving the fifth and sixth lens groups G5 and G6 along the optical axis. When focus is shifted from infinity to a nearby object, the fifth lens group G5 moves from the object side toward the image plane side whereas the sixth lens group G6 moves from the image plane side toward the object side.

The variable magnification optical system of the present example can change a focused state at a predetermined object distance from a first focused state to a second focused state by moving the fifth and sixth lens groups G5 and G6 along the optical axis from the image plane side toward the object side or vice versa.

In the variable magnification optical system of the present example, the fourth, fifth, sixth, and seventh lens groups G4, G5, G6, and G7 correspond to the rear group. The fifth and sixth lens groups G5 and G6 correspond to the first and second focusing lens groups, respectively.

Table 6 below shows specifications of the variable magnification optical system of the present example.

TABLE 6
[General specifications]

| | |
|---|---|
| TLW | 294.62 |
| TLT | 357.71 |
| fW | 203.70 |
| fT | 573.28 |
| FNoW | 6.54 |
| FNoT | 7.52 |
| Y | 21.60 |
| 2ωW | 11.95 |
| 2ωT | 4.24 |

[Lens specifications]

| m | r | d | nd | νd | |
|---|---|---|---|---|---|
| 1) | 459.721 | 3.000 | 1.834000 | 37.35 | |
| 2) | 155.194 | 10.050 | 1.497000 | 81.61 | |
| 3) | −578.521 | 0.200 | | | |
| 4) | 129.596 | 9.100 | 1.497000 | 81.61 | |
| 5) | 8801.451 | D5 | | | |
| 6) | 946.176 | 5.500 | 1.805180 | 25.45 | |
| 7) | −64.381 | 1.600 | 1.700000 | 48.11 | |
| 8) | 70.812 | 4.958 | | | |
| 9) | 60.083 | 5.387 | 1.846660 | 23.80 | |
| 10) | 8796.211 | 1.400 | 1.804000 | 46.60 | |
| 11) | 71.565 | 4.551 | | | |
| 12) | −70.018 | 1.500 | 1.921190 | 23.96 | |
| 13) | 778.187 | D13 | | | |
| 14) | 91.070 | 4.700 | 1.497000 | 81.61 | |
| 15) | −116.772 | 0.200 | | | |
| 16) | 65.543 | 5.300 | 1.487490 | 70.44 | |
| 17) | −290.558 | 0.200 | | | |
| 18) | 51.411 | 6.000 | 1.487490 | 70.44 | |
| 19) | −111.623 | 1.500 | 1.903660 | 31.31 | |
| 20) | 153.603 | 10.000 | | | |
| 21> | ∞ | 5.718 | (aperture stop) | | |
| 22) | 609.146 | 5.596 | 1.850260 | 32.35 | |
| 23) | −31.501 | 1.000 | 1.795000 | 45.31 | |
| 24) | 36.192 | 4.500 | | | |
| 25) | ∞ | D25 | (virtual plane) | | |
| 26) | 58.357 | 4.200 | 1.531720 | 48.78 | |
| 27) | −123.367 | 0.388 | | | |
| 28) | 78.896 | 5.000 | 1.595510 | 39.21 | |
| 29) | −48.907 | 1.000 | 1.846660 | 23.80 | |
| 30) | −537.423 | 0.000 | | | |
| 31) | ∞ | D31 | (virtual plane) | | |
| 32) | 74.871 | 1.000 | 1.729160 | 54.61 | (F) |
| 33) | 40.435 | D33 | | | |
| 34) | −128.033 | 4.000 | 1.698950 | 30.13 | (F) |
| 35) | −32.473 | D35 | | | |
| 36) | −31.966 | 1.000 | 1.603000 | 65.44 | |
| 37) | 206.206 | D37 | | | |

[Focal length data of groups]

| Groups | Starting surfaces | Focal lengths |
|---|---|---|
| G1 | 1 | 125.04 |
| G1 | 1 | 233.33 |
| G2 | 6 | −53.11 |
| G3 | 14 | 83.52 |
| G4 | 26 | 57.36 |
| G5 | 32 | −121.54 |
| G6 | 34 | 60.71 |
| G7 | 36 | −45.66 |

[Variable distance data]

| | <Wide-angle end> | | | | <Telephoto end> | | | |
|---|---|---|---|---|---|---|---|---|
| | | <Close range> | | | | <Close range> | | |
| | <Infinity> | First focus | Second focus | Third focus | <Infinity> | First focus | Second focus | Third focus |
| D5 | 32.82 | 32.82 | 32.82 | 32.82 | 114.43 | 114.43 | 114.43 | 114.43 |
| D13 | 36.44 | 36.44 | 36.44 | 36.44 | 3.99 | 3.99 | 3.99 | 3.99 |
| D25 | 0.39 | 0.39 | 0.39 | 0.39 | 4.41 | 4.41 | 4.41 | 4.41 |
| D31 | 9.65 | 18.76 | 8.60 | 10.52 | 2.18 | 21.58 | 1.40 | 2.94 |
| D33 | 21.80 | 12.00 | 22.20 | 21.48 | 22.36 | 2.36 | 22.66 | 22.07 |
| D35 | 1.92 | 2.61 | 2.57 | 1.37 | 0.69 | 1.29 | 1.17 | 0.23 |
| D37 | 82.50 | 82.50 | 82.50 | 82.50 | 99.03 | 99.03 | 99.03 | 99.03 |

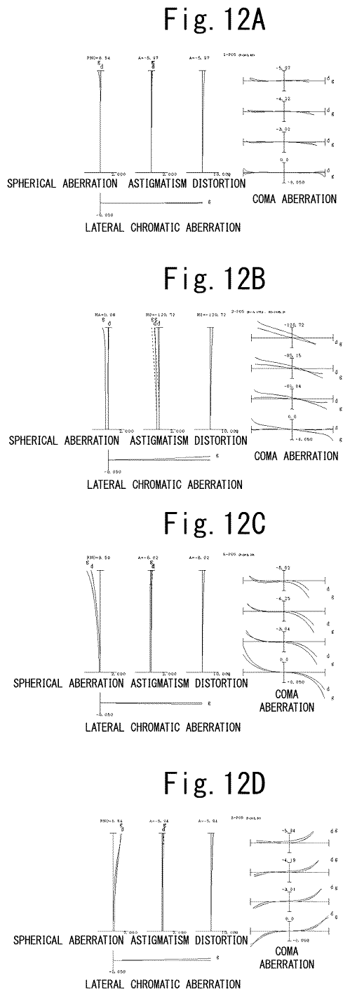

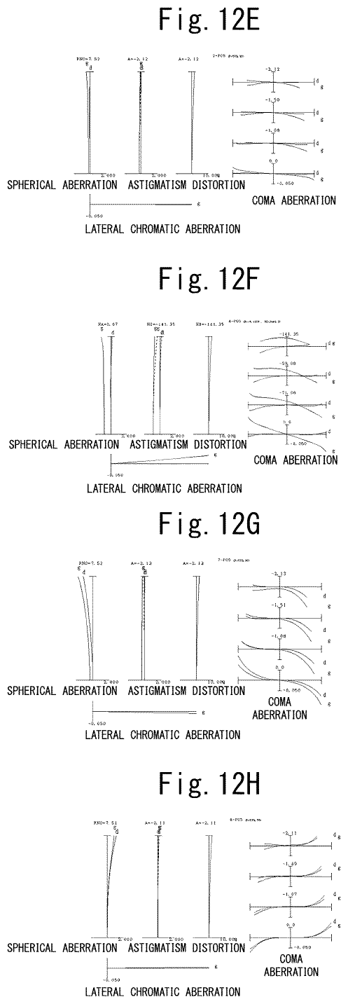

FIG. 12A shows aberrations of the variable magnification optical system of the sixth example at focusing on an object at infinity in the wide-angle end state; FIGS. 12B, 12C, and 12D show aberrations of the variable magnification optical system of the sixth example at first focusing, second focusing, and third focusing on a nearby object in the wide-angle end state, respectively; FIG. 12E shows aberrations of the variable magnification optical system of the sixth example at focusing on an object at infinity in the telephoto end state; FIGS. 12F, 12G, and 12H show aberrations of the variable magnification optical system of the sixth example at first focusing, second focusing, and third focusing on a nearby object in the telephoto end state, respectively.

The graphs of aberrations suggest that the variable magnification optical system of the present example effectively reduces variations in aberrations at focusing and at varying magnification and has high optical performance.

### Seventh Example

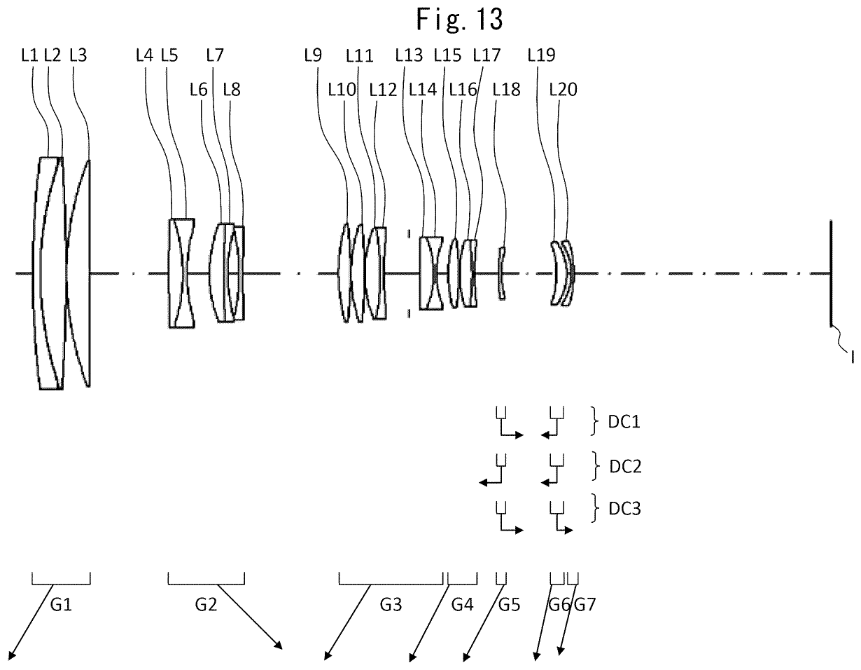

FIG. 13 is a cross-sectional view of a variable magnification optical system of a seventh example at focusing on an object at infinity in the wide-angle end state.

The variable magnification optical system of the present example includes, in order from the object side, a first lens group G1 having positive refractive power, a second lens group G2 having negative refractive power, third and fourth lens groups G3 and G4 having positive refractive power, a fifth lens group G5 having negative refractive power, a sixth lens group G6 having positive refractive power, and a seventh lens group G7 having negative refractive power.

The first lens group G1 consists of, in order from the object side, a positive cemented lens composed of a meniscus-shaped negative lens L1 convex on the object side and a biconvex positive lens L2, and a meniscus-shaped positive lens L3 convex on the object side.

The second lens group G2 consists of, in order from the object side, a negative cemented lens composed of a biconvex positive lens L4 and a biconcave negative lens L5, a positive cemented lens composed of a meniscus-shaped positive lens L6 convex on the object side and a meniscus-shaped negative lens L7 convex on the object side, and a biconcave negative lens L8.

The third lens group G3 consists of, in order from the object side, biconvex positive lenses L9 and L10, a negative cemented lens composed of a biconvex positive lens L11 and a biconcave negative lens L12, an aperture stop S, and a negative cemented lens composed of a biconvex positive lens L13 and a biconcave negative lens L14.

The fourth lens group G4 consists of, in order from the object side, a biconvex positive lens L15 and a positive cemented lens composed of a biconvex positive lens L16 and a biconcave negative lens L17.

The fifth lens group G5 consists of a meniscus-shaped negative lens L18 convex on the object side.

The sixth lens group G6 consists of a meniscus-shaped positive lens L19 concave on the object side.

The seventh lens group G7 consists of a meniscus-shaped negative lens L20 concave on the object side.

An imaging device (not shown) constructed from CCD, CMOS, or the like is disposed on an image plane I.

The variable magnification optical system of the present example focuses by moving the fifth and sixth lens groups G5 and G6 along the optical axis. When focus is shifted from infinity to a nearby object, the fifth lens group G5 moves from the object side toward the image plane side whereas the sixth lens group G6 moves from the image plane side toward the object side.

The variable magnification optical system of the present example can change a focused state at a predetermined object distance from a first focused state to a second focused state by moving the fifth and sixth lens groups G5 and G6 along the optical axis from the image plane side toward the object side or vice versa.

In the variable magnification optical system of the present example, the fourth, fifth, sixth, and seventh lens groups G4, G5, G6, and G7 correspond to the rear group. The fifth and sixth lens groups G5 and G6 correspond to the first and second focusing lens groups, respectively.

Table 7 below shows specifications of the variable magnification optical system of the present example.

TABLE 7
[General specifications]

| | |
|---|---|
| TLW | 314.46 |
| TLT | 380.07 |
| fW | 198.16 |
| fT | 570.84 |
| FNoW | 6.77 |
| FNoT | 7.83 |
| Y | 21.60 |
| 2ωW | 12.34 |
| 2ωT | 4.29 |

[Lens specifications]

| m | r | d | nd | νd | |
|---|---|---|---|---|---|
| 1) | 408.403 | 3.000 | 1.834000 | 37.35 | |
| 2) | 148.061 | 10.050 | 1.497000 | 81.61 | |
| 3) | −669.305 | 0.200 | | | |
| 4) | 130.831 | 9.100 | 1.497000 | 81.61 | |
| 5) | 11091.231 | D5 | | | |
| 6) | 758.403 | 5.500 | 1.805180 | 25.45 | |
| 7) | −67.708 | 1.600 | 1.700000 | 48.11 | |
| 8) | 68.129 | 8.887 | | | |
| 9) | 56.578 | 5.775 | 1.846660 | 23.80 | |
| 10) | 676.909 | 1.400 | 1.804000 | 46.60 | |
| 11) | 67.159 | 4.487 | | | |
| 12) | −74.167 | 1.500 | 1.921190 | 23.96 | |
| 13) | 511.493 | D13 | | | |
| 14) | 78.165 | 4.700 | 1.497000 | 81.61 | |
| 15) | −191.776 | 0.200 | | | |
| 16) | 62.679 | 5.300 | 1.487490 | 70.45 | |
| 17) | −208.293 | 0.200 | | | |
| 18) | 54.422 | 6.000 | 1.487490 | 70.45 | |
| 19) | −101.135 | 1.500 | 1.903660 | 31.31 | |
| 20) | 155.030 | 10.000 | | | |
| 21> | ∞ | 4.023 | (aperture stop) | | |
| 22) | 407.419 | 5.571 | 1.850260 | 32.35 | |
| 23) | −35.608 | 1.000 | 1.795000 | 45.31 | |
| 24) | 34.247 | 4.500 | | | |
| 25) | ∞ | D25 | (virtual plane) | | |
| 26) | 54.480 | 4.200 | 1.531720 | 48.78 | |
| 27) | −91.472 | 0.200 | | | |
| 28) | 44.643 | 5.000 | 1.595510 | 39.21 | |
| 29) | −103.691 | 1.000 | 1.896450 | 26.28 | |
| 30) | 106.753 | 0.000 | | | |
| 31) | ∞ | D31 | (virtual plane) | | |
| 32) | 402.532 | 1.000 | 1.456000 | 91.37 | |
| 33) | 41.271 | D33 | | | |
| 34) | −34.286 | 4.000 | 1.606520 | 43.12 | (F) |
| 35) | −21.926 | D35 | | | |
| 36) | −21.517 | 1.000 | 1.498000 | 90.00 | |
| 37) | −42.265 | D37 | | | |

[Focal length data of groups]

| Groups | Starting surfaces | Focal lengths |
|---|---|---|
| G1 | 1 | 234.56 |
| G2 | 6 | −52.49 |
| G3 | 14 | 97.34 |
| G4 | 26 | 53.86 |
| G5 | 32 | −100.67 |
| G6 | 34 | 88.84 |
| G7 | 36 | −89.21 |

[Variable distance data]

| | <Wide-angle end> | | | | <Telephoto end> | | | |
|---|---|---|---|---|---|---|---|---|
| | | <Close range> | | | | <Close range> | | |
| | <Infinity> | First focus | Second focus | Third focus | <Infinity> | First focus | Second focus | Third focus |
| D5 | 31.18 | 31.18 | 31.18 | 31.18 | 114.55 | 114.55 | 114.55 | 114.55 |
| D13 | 37.68 | 37.68 | 37.68 | 37.68 | 1.51 | 1.51 | 1.51 | 1.51 |
| D25 | 0.20 | 0.20 | 0.20 | 0.20 | 5.11 | 5.11 | 5.11 | 5.11 |
| D31 | 9.65 | 18.02 | 9.26 | 10.03 | 2.19 | 20.82 | 1.88 | 2.51 |
| D33 | 21.62 | 12.92 | 21.59 | 21.64 | 21.83 | 3.24 | 21.83 | 21.88 |
| D35 | 1.80 | 2.15 | 2.27 | 1.37 | 0.87 | 0.83 | 1.22 | 0.50 |
| D37 | 101.39 | 101.39 | 101.39 | 101.39 | 121.51 | 121.51 | 121.51 | 121.51 |

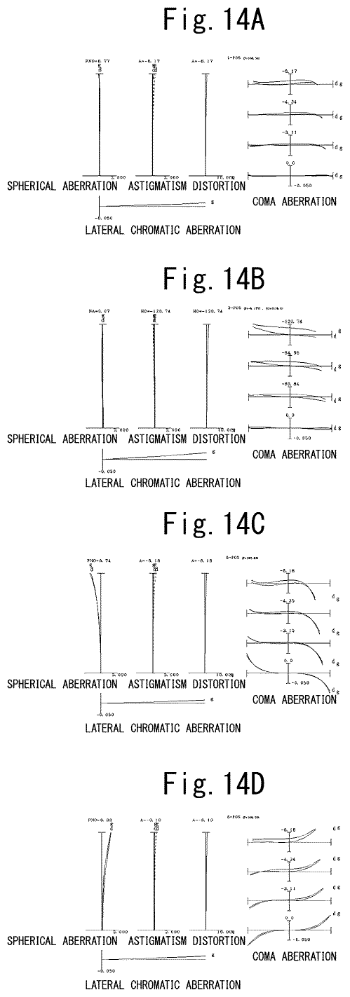

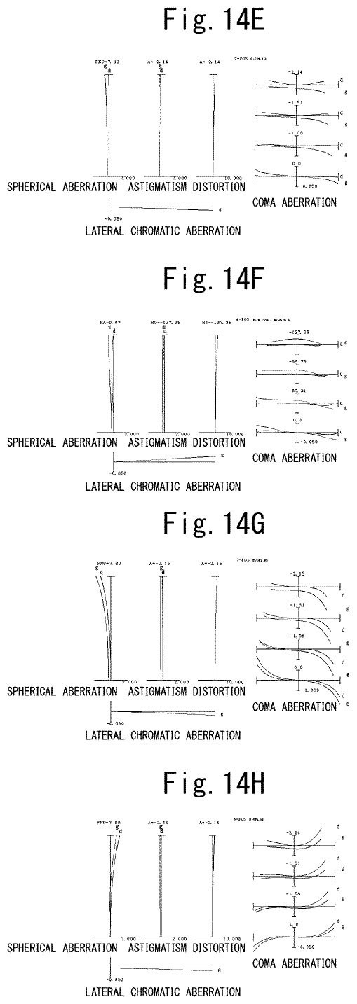

FIG. 14A shows aberrations of the variable magnification optical system of the seventh example at focusing on an object at infinity in the wide-angle end state; FIGS. 14B, 14C, and 14D show aberrations of the variable magnification optical system of the seventh example at first focusing, second focusing, and third focusing on a nearby object in the wide-angle end state, respectively; FIG. 14E shows aberrations of the variable magnification optical system of the seventh example at focusing on an object at infinity in the telephoto end state; FIGS. 14F, 14G, and 14H show aberrations of the variable magnification optical system of the seventh example at first focusing, second focusing, and third focusing on a nearby object in the telephoto end state, respectively.

The graphs of aberrations suggest that the variable magnification optical system of the present example effectively reduces variations in aberrations at focusing and at varying magnification and has high optical performance.

### Eighth Example

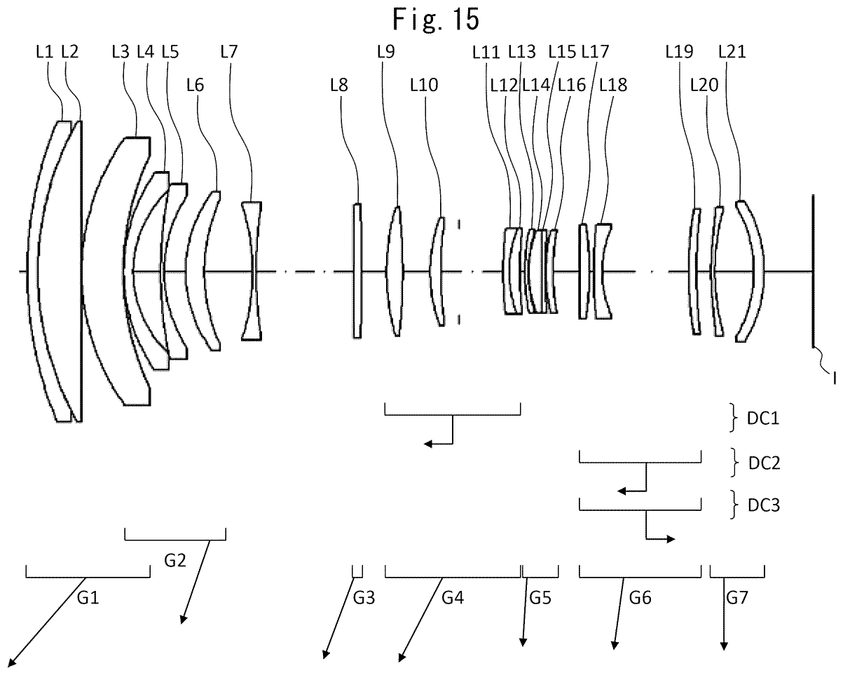

FIG. 15 is a cross-sectional view of a variable magnification optical system of an eighth example at focusing on an object at infinity in the wide-angle end state.

The variable magnification optical system of the present example includes, in order from the object side, a first lens group G1 having positive refractive power, a second lens group G2 having negative refractive power, third, fourth, and fifth lens groups G3, G4, and G5 having positive refractive power, and sixth and seventh lens groups G6 and G7 having negative refractive power.

The first lens group G1 consists of, in order from the object side, a positive cemented lens composed of a meniscus-shaped negative lens L1 convex on the object side and a planoconvex lens L2 convex on the object side, and a meniscus-shaped positive lens L3 convex on the object side.

The second lens group G2 consists of, in order from the object side, meniscus-shaped negative lenses L4 and L5 convex on the object side, a meniscus-shaped positive lens L6 convex on the object side, and a biconcave negative lens L7.

The third lens group G3 consists of a biconvex positive lens L8.

The fourth lens group G4 consists of, in order from the object side, a biconvex positive lens L9, a meniscus-shaped positive lens L10 convex on the object side, an aperture stop S, and a negative cemented lens composed of a meniscus-shaped negative lens L11 convex on the object side and a meniscus-shaped positive lens L12 convex on the object side.

The fifth lens group G5 consists of, in order from the object side, a meniscus-shaped negative lens L13 convex on the object side, a positive cemented lens composed of a biconvex positive lens L14 and a biconcave negative lens L15, and a meniscus-shaped positive lens L16 convex on the object side.

The sixth lens group G6 consists of, in order from the object side, a biconvex positive lens L17, a meniscus-shaped negative lens L18 convex on the object side, and a meniscus-shaped positive lens L19 convex on the object side.

The seventh lens group G7 consists of, in order from the object side, a meniscus-shaped negative lens L20 convex on the object side and a meniscus-shaped negative lens L21 concave on the object side.

An imaging device (not shown) constructed from CCD, CMOS, or the like is disposed on an image plane I.

The variable magnification optical system of the present example focuses by moving the fourth lens group G4 along the optical axis. When focus is shifted from infinity to a nearby object, the fourth lens group G4 moves from the image plane side toward the object side.

The variable magnification optical system of the present example can change a focused state at a predetermined object distance from a first focused state to a second focused state by moving the sixth lens group G6 along the optical axis from the image plane side toward the object side or vice versa.

In the variable magnification optical system of the present example, the fourth, fifth, sixth, and seventh lens groups G4, G5, G6, and G7 correspond to the rear group. The fourth lens group G4 corresponds to the focusing lens group, and the sixth lens group G6 corresponds to the variable aberration lens group.

Table 8 below shows specifications of the variable magnification optical system of the present example.

TABLE 8
[General specifications]

| | |
|---|---|
| TLW | 249.90 |
| TLT | 282.95 |
| fW | 70.50 |
| fT | 139.35 |
| FNoW | 4.00 |
| FNoT | 4.59 |
| Y | 21.60 |
| 2ωW | 33.81 |
| 2ωT | 17.31 |

[Lens specifications]

| m | r | d | nd | νd | |
|---|---|---|---|---|---|
| 1) | 109.629 | 3.000 | 2.001000 | 29.12 | |
| 2) | 85.136 | 12.321 | 1.497820 | 82.57 | |
| 3) | ∞ | 0.100 | | | |
| 4) | 63.748 | 11.835 | 1.433840 | 95.16 | |
| *5) | 74.618 | D5 | | | |
| 6) | 48.477 | 2.679 | 1.603000 | 65.44 | |
| 7) | 31.266 | 7.776 | | | |
| 8) | 116.755 | 1.000 | 1.497820 | 82.57 | |
| 9) | 38.827 | 6.078 | | | |
| 10) | 36.781 | 5.303 | 1.663820 | 27.35 | |
| 11) | 49.283 | 13.691 | | | |
| 12) | −58.843 | 1.000 | 1.497820 | 82.57 | |
| 13) | 118.752 | D13 | | | |
| 14) | 5949.642 | 2.178 | 1.945950 | 17.98 | |
| 15) | −402.031 | D15 | | | |
| 16) | 66.198 | 4.586 | 1.497820 | 82.57 | (FDC) |
| 17) | −166.782 | 7.768 | | | |
| 18) | 44.179 | 3.000 | 1.497820 | 82.57 | (FDC) |
| 19) | 91.751 | 5.157 | | | |
| 20> | ∞ | 12.531 | (aperture stop) | | |
| 21) | 106.468 | 1.748 | 1.922860 | 20.88 | (FDC) |
| 22) | 33.980 | 3.013 | 1.497820 | 82.57 | (FDC) |
| 23) | 112.524 | D23 | | | |
| 24) | 58.088 | 1.000 | 1.850260 | 32.35 | |
| 25) | 36.655 | 0.100 | | | |
| *26) | 31.967 | 3.749 | 1.592010 | 66.89 | |
| 27) | −537.312 | 1.000 | 1.620040 | 36.40 | |
| 28) | 200.873 | 0.100 | | | |
| 29) | 49.500 | 2.099 | 1.801000 | 34.92 | |
| *30) | 67.041 | D30 | | | |
| 31) | 535.980 | 2.822 | 1.945950 | 17.98 | (Z) (FDC) |
| *32) | −81.000 | 1.158 | | | |
| 33) | 112.380 | 2.458 | 1.713000 | 53.96 | (FDC) |
| 34) | 31.208 | 24.554 | | | |
| *35) | 132.350 | 2.215 | 1.902650 | 35.77 | (FDC) |
| 36) | 157.371 | D36 | | | |
| *37) | 87.217 | 1.072 | 1.516120 | 63.84 | |
| 38) | 65.869 | 11.018 | | | |
| 39) | −35.035 | 3.000 | 1.563840 | 60.71 | |
| 40) | −36.251 | 14.510 | | | |

[Aspherical surface data]

| m | K | A4 | A6 | A8 | A10 | A12 |
|---|---|---|---|---|---|---|
| 5) | 0.0000 | 1.34E−09 | 5.63E−11 | −2.02E−14 | 4.08E−18 | |
| 26) | 0.0000 | −1.79E−06 | −6.23E−09 | −3.44E−11 | 1.53E−14 | 3.05E−17 |
| 30) | 0.0000 | 4.10E−06 | −3.38E−09 | −2.44E−11 | −3.99E−14 | |
| 32) | 0.0000 | 2.02E−07 | 8.29E−10 | −1.51E−11 | 7.40E−14 | |
| 35) | 0.0000 | 3.64E−06 | −1.38E−09 | 1.78E−12 | 2.53E−15 | |
| 37) | 0.0000 | −4.80E−06 | 3.78E−09 | −1.14E−11 | 2.35E−14 | −3.24E−17 |

[Focal length data of groups]

| Groups | Starting surfaces | Focal lengths |
|---|---|---|
| G1 | 1 | 211.71 |
| G2 | 6 | −38.91 |
| G3 | 14 | 398.17 |
| G4 | 16 | 86.23 |
| G5 | 24 | 87.88 |
| G6 | 31 | −977.28 |
| G7 | 37 | −529.17 |

[Variable distance data]

| | <Wide-angle end> | | | | <Telephoto end> | | | |
|---|---|---|---|---|---|---|---|---|
| | | <Close range> | | | | <Close range> | | |
| | <Infinity> | First focus | Second focus | Third focus | <Infinity> | First focus | Second focus | Third focus |
| D5 | 0.10 | 0.10 | 0.10 | 0.10 | 46.07 | 46.07 | 46.07 | 46.07 |
| D13 | 27.79 | 27.79 | 27.79 | 27.79 | 12.20 | 12.20 | 12.20 | 12.20 |
| D15 | 7.03 | 8.37 | 7.03 | 7.03 | 5.06 | 7.99 | 5.06 | 5.06 |
| D23 | 1.38 | 0.10 | 1.38 | 1.38 | 2.68 | 0.20 | 2.68 | 2.68 |
| D30 | 7.47 | 7.47 | 2.39 | 11.18 | 3.39 | 3.39 | 0.89 | 5.79 |
| D36 | 4.11 | 4.11 | 9.58 | 0.10 | 21.23 | 21.23 | 24.03 | 18.57 |

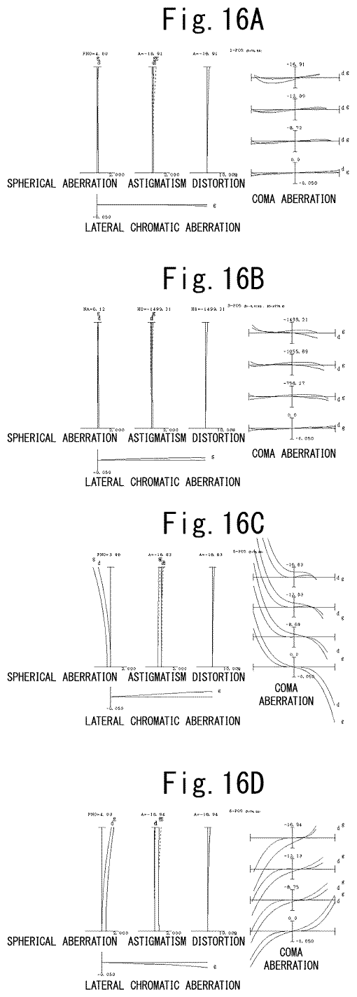

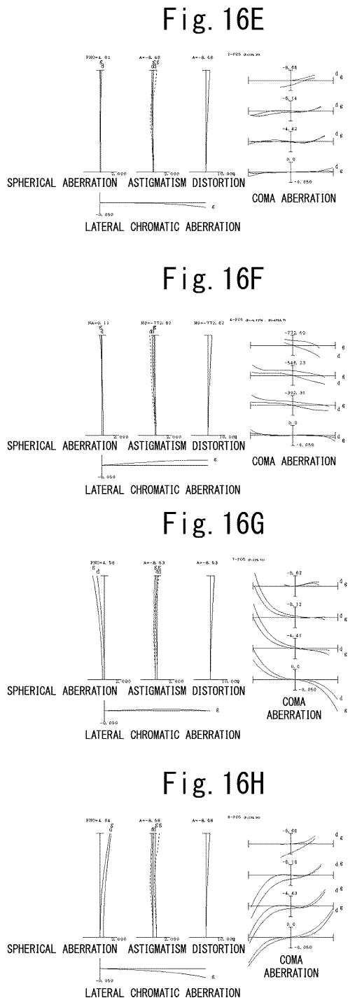

FIG. 16A shows aberrations of the variable magnification optical system of the eighth example at focusing on an object at infinity in the wide-angle end state; FIGS. 16B, 16C, and 16D show aberrations of the variable magnification optical system of the eighth example at first focusing, second focusing, and third focusing on a nearby object in the wide-angle end state, respectively; FIG. 16E shows aberrations of the variable magnification optical system of the eighth example at focusing on an object at infinity in the telephoto end state; FIGS. 16F, 16G, and 16H show aberrations of the variable magnification optical system of the eighth example at first focusing, second focusing, and third focusing on a nearby object in the telephoto end state, respectively.

The graphs of aberrations suggest that the variable magnification optical system of the present example effectively reduces variations in aberrations at focusing and at varying magnification and has high optical performance.

### Ninth Example

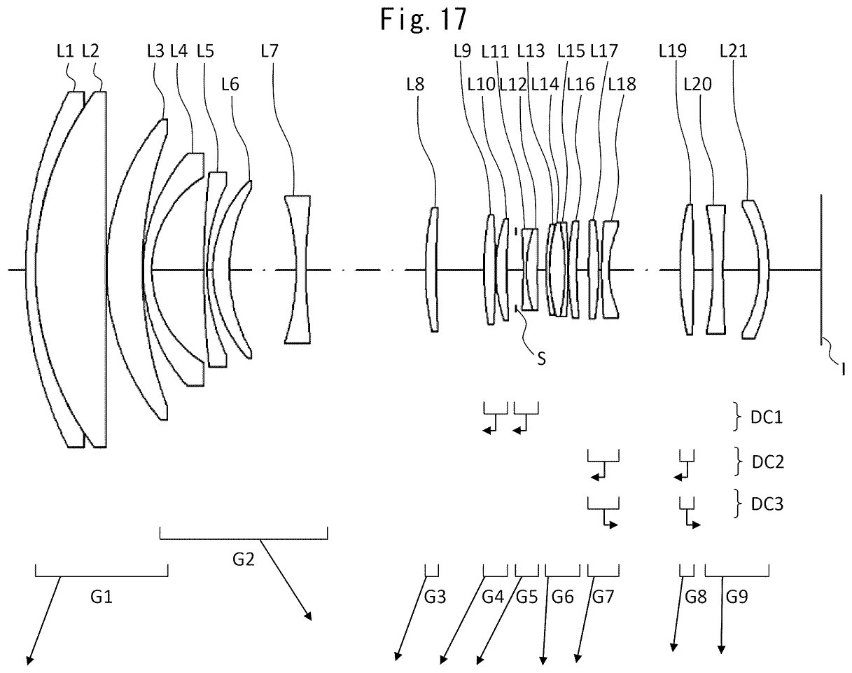

FIG. 17 is a cross-sectional view of a variable magnification optical system of a ninth example at focusing on an object at infinity in the wide-angle end state.

The variable magnification optical system of the present example includes, in order from the object side, a first lens group G1 having positive refractive power, a second lens group G2 having negative refractive power, third and fourth lens groups G3 and G4 having positive refractive power, a fifth lens group G5 having negative refractive power, a sixth lens group G6 having positive refractive power, a seventh lens group G7 having negative refractive power, an eighth lens group G8 having positive refractive power, and a ninth lens group G9 having negative refractive power.

The first lens group G1 consists of, in order from the object side, a positive cemented lens composed of a meniscus-shaped negative lens L1 convex on the object side and a planoconvex lens L2 convex on the object side, and a meniscus-shaped positive lens L3 convex on the object side.

The second lens group G2 consists of, in order from the object side, meniscus-shaped negative lenses L4 and L5 convex on the object side, a meniscus-shaped positive lens L6 convex on the object side, and a biconcave negative lens L7.

The third lens group G3 consists of a meniscus-shaped positive lens L8 convex on the object side.

The fourth lens group G4 consists of, in order from the object side, a biconvex positive lens L9 and a meniscus-shaped positive lens L10 convex on the object side.

The fifth lens group G5 consists of, in order from the object side, an aperture stop S and a negative cemented lens composed of a biconcave negative lens L11 and a meniscus-shaped positive lens L12 convex on the object side.

The sixth lens group G6 consists of, in order from the object side, a meniscus-shaped negative lens L13 convex on the object side, a positive cemented lens composed of a biconvex positive lens L14 and a meniscus-shaped negative lens L15 concave on the object side, and a meniscus-shaped positive lens L16 convex on the object side.

The seventh lens group G7 consists of, in order from the object side, a biconvex positive lens L17 and a meniscus-shaped negative lens L18 convex on the object side.

The eighth lens group G8 consists of a biconvex positive lens L19.

The ninth lens group G9 consists of, in order from the object side, a biconcave negative lens L20 and a meniscus-shaped negative lens L21 concave on the object side.

An imaging device (not shown) constructed from CCD, CMOS, or the like is disposed on an image plane I.

The variable magnification optical system of the present example focuses by moving the fourth and fifth lens groups G4 and G5 along the optical axis. When focus is shifted from infinity to a nearby object, the fourth and fifth lens groups G4 and G5 move from the image plane side toward the object side.

The variable magnification optical system of the present example can change a focused state at a predetermined object distance from a first focused state to a second focused state by moving the seventh and eighth lens groups G7 and G8 along the optical axis from the image plane side toward the object side or vice versa.

In the variable magnification optical system of the present example, the fourth, fifth, sixth, seventh, eighth, and ninth lens groups G4, G5, G6, G7, G8, and G9 correspond to the rear group. The fourth and fifth lens groups G4 and G5 correspond to the focusing lens group, and the seventh and eighth lens groups G7 and G8 correspond to the variable aberration lens group.

Table 9 below shows specifications of the variable magnification optical system of the present example.

TABLE 9
[General specifications]

| | |
|---|---|
| TLW | 243.79 |
| TLT | 250.08 |
| fW | 70.31 |
| fT | 139.00 |
| FNoW | 4.00 |
| FNoT | 4.22 |
| Y | 21.60 |
| 2ωW | 34.89 |
| 2ωT | 17.75 |

[Lens specifications]

| m | r | d | nd | νd | |
|---|---|---|---|---|---|
| 1) | 111.205 | 3.000 | 2.001000 | 29.12 | |
| 2) | 84.962 | 21.600 | 1.497820 | 82.57 | |
| 3) | ∞ | 0.100 | | | |
| 4) | 67.241 | 10.950 | 1.433840 | 95.16 | |
| *5) | 109.854 | D5 | | | |
| 6) | 49.907 | 2.677 | 1.603000 | 65.44 | |
| 7) | 31.569 | 15.883 | | | |
| 8) | 256.551 | 1.000 | 1.497820 | 82.57 | |
| 9) | 56.598 | 1.775 | | | |
| 10) | 36.670 | 5.054 | 1.663820 | 27.35 | |
| 11) | 46.659 | 20.424 | | | |
| 12) | −65.286 | 3.000 | 1.497820 | 82.57 | |
| 13) | 160.244 | D13 | | | |
| 14) | 86.089 | 3.332 | 1.945950 | 17.98 | |
| 15) | 413.916 | D15 | | | |
| 16) | 97.477 | 3.501 | 1.497820 | 82.57 | (FDC) |
| 17) | −207.488 | 0.127 | | | |
| 18) | 47.603 | 3.279 | 1.497820 | 82.57 | (FDC) |
| 19) | 151.121 | D19 | | | |
| 20> | ∞ | 2.248 | (aperture stop) | | |
| 21) | −175.858 | 1.000 | 1.922860 | 20.88 | (FDC) |
| 22) | 38.679 | 3.349 | 1.497820 | 82.57 | (FDC) |
| 23) | 931.596 | D23 | | | |
| 24) | 71.217 | 1.000 | 1.850260 | 32.35 | |
| 25) | 48.536 | 0.100 | | | |
| *26) | 45.661 | 4.668 | 1.592010 | 66.89 | |
| 27) | −62.834 | 1.000 | 1.620040 | 36.40 | |
| 28) | −170.484 | 0.100 | | | |
| 29) | 74.758 | 2.521 | 1.801000 | 34.92 | |
| *30) | 144.739 | D30 | | | |
| 31) | 496.091 | 2.956 | 1.945950 | 17.98 | (Z) (FDC) |
| *32) | −100.186 | 0.977 | | | |
| 33) | 168.990 | 2.201 | 1.713000 | 53.96 | (FDC) |
| 34) | 30.909 | D34 | | | |
| *35) | 92.535 | 4.160 | 1.902650 | 35.77 | (FDC) |
| 36) | −374.510 | D36 | | | |
| *37) | −78.960 | 3.000 | 1.516120 | 63.84 | |
| 38) | 308.128 | 11.101 | | | |
| 39) | −35.035 | 2.921 | 1.563840 | 60.71 | |
| 40) | −47.413 | 16.700 | | | |

[Aspherical surface data]

| m | K | A4 | A6 | A8 | A10 | A12 |
|---|---|---|---|---|---|---|
| 5) | 0.0000 | −1.06E−09 | −1.71E−12 | −9.66E−16 | 9.64E−20 | |
| 26) | 0.0000 | −2.58E−06 | −3.77E−10 | −1.70E−11 | 2.85E−14 | −1.75E−16 |
| 30) | 0.0000 | 1.49E−06 | −4.57E−10 | −6.78E−12 | 4.95E−15 | |
| 32) | 0.0000 | −1.01E−06 | −1.40E−09 | −2.28E−12 | −9.12E−15 | |
| 35) | 0.0000 | 1.57E−06 | 1.28E−09 | −4.22E−12 | 7.99E−16 | |
| 37) | 0.0000 | 6.38E−07 | 2.43E−09 | −9.07E−12 | 3.58E−14 | −1.94E−17 |

[Focal length data of groups]

| Groups | Starting surfaces | Focal lengths |
|---|---|---|
| G1 | 1 | 172.67 |
| G2 | 6 | −42.59 |
| G3 | 14 | 114.34 |
| G4 | 16 | 68.13 |
| G5 | 20 | −59.45 |
| G6 | 24 | 63.77 |
| G7 | 31 | −146.94 |
| G8 | 35 | 82.55 |
| G9 | 37 | −81.33 |

[Variable distance data]

| | <Wide-angle end> | | | | <Telephoto end> | | | |
|---|---|---|---|---|---|---|---|---|
| | | <Close range> | | | | <Close range> | | |
| | <Infinity> | First focus | Second focus | Third focus | <Infinity> | First focus | Second focus | Third focus |
| D5 | 0.23 | 0.23 | 0.23 | 0.23 | 32.30 | 32.30 | 32.30 | 32.30 |
| D13 | 36.52 | 36.52 | 36.52 | 36.52 | 11.08 | 11.08 | 11.08 | 11.08 |
| D15 | 14.58 | 12.54 | 14.58 | 14.58 | 8.11 | 4.05 | 8.11 | 8.11 |
| D19 | 2.82 | 4.25 | 2.82 | 2.82 | 5.60 | 8.40 | 5.60 | 5.60 |
| D23 | 2.61 | 3.21 | 2.61 | 2.61 | 1.01 | 2.26 | 1.01 | 1.01 |
| D30 | 3.74 | 3.74 | 1.37 | 6.13 | 3.16 | 3.16 | 0.70 | 5.59 |
| D34 | 21.72 | 21.72 | 23.29 | 21.82 | 27.44 | 27.44 | 29.88 | 26.74 |
| D36 | 5.97 | 5.97 | 7.41 | 3.86 | 5.78 | 5.78 | 7.04 | 3.90 |

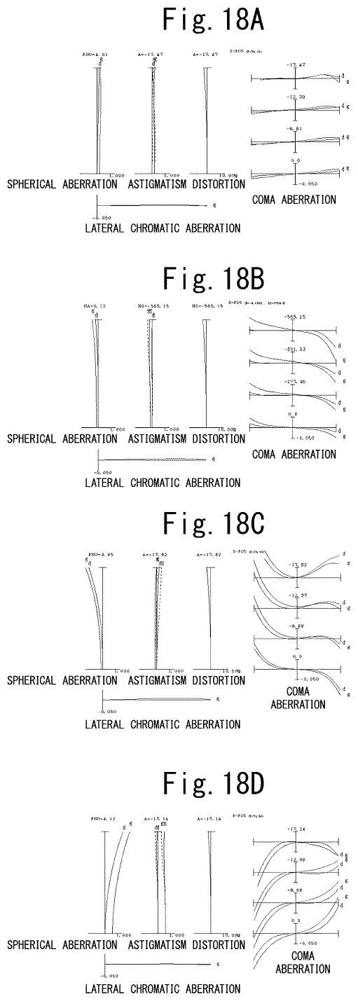

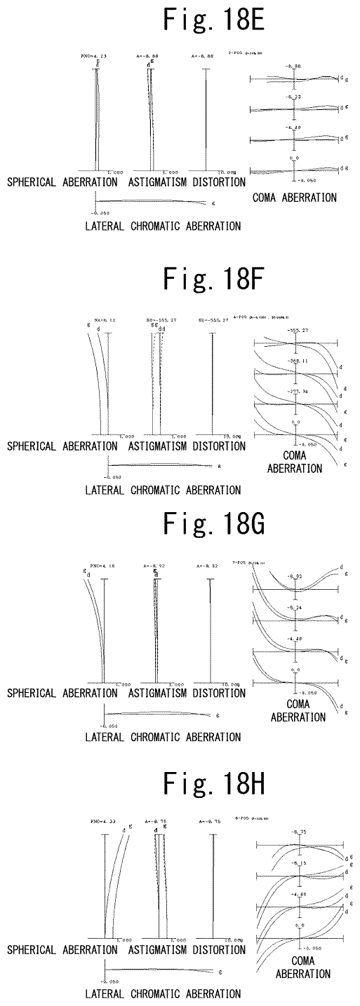

FIG. 18A shows aberrations of the variable magnification optical system of the ninth example at focusing on an object at infinity in the wide-angle end state; FIGS. 18B, 18C, and 18D show aberrations of the variable magnification optical system of the ninth example at first focusing, second focusing, and third focusing on a nearby object in the wide-angle end state, respectively; FIG. 18E shows aberrations of the variable magnification optical system of the ninth example at focusing on an object at infinity in the telephoto end state; FIGS. 18F, 18G, and 18H show aberrations of the variable magnification optical system of the ninth example at first focusing, second focusing, and third focusing on a nearby object in the telephoto end state, respectively.

The graphs of aberrations suggest that the variable magnification optical system of the present example effectively reduces variations in aberrations at focusing and at varying magnification and has high optical performance.

A variable magnification optical system of favorable optical performance can be achieved according to the above examples.

Values for the conditional expressions of the examples are listed below.
f1 and f2 are the focal lengths of the first and second lens groups, respectively. Dsr1W is the distance on the optical axis between the aperture stop and an object-side surface of a lens disposed closest to the object side in the first focusing lens group at focusing on infinity in the wide-angle end state; TLW is the total length of the optical system in the wide-angle end state. Dsr1T is the distance on the optical axis between the aperture stop and an object-side surface of a lens disposed closest to the object side in the first focusing lens group at focusing on infinity in the telephoto end state; TLT is the total length of the optical system in the telephoto end state. Dsr2W is the distance on the optical axis between the aperture stop and an object-side surface of a lens disposed closest to the object side in the second focusing lens group at focusing on infinity in the wide-angle end state; Dsr1T is the distance on the optical axis between the aperture stop and an object-side surface of a lens disposed closest to the object side in the second focusing lens group at focusing on infinity in the telephoto end state. DsiW is the distance on the optical axis between the aperture stop and the image plane at focusing on infinity in the wide-angle end state; DsiT is the distance on the optical axis between the aperture stop and the image plane at focusing on infinity in the telephoto end state.
ndLZ is the refractive index of the lens Z at d-line; θgFLZ is the partial dispersion ratio of the lens Z defined by the following expression:

$$θ gFLZ = ( ngLZ - nFLZ ) / ( nFLX - nCLZ )$$

where ngLZ, nFLZ, and nCLZ denote the refractive indices of the lens Z at g-line, F-line, and C-line, respectively.
ndF is the refractive index at d-line of the lens included in the first or second focusing lens group. fF1 and fF2 are the focal lengths of the first and second focusing lens groups, respectively. ndFDC is the refractive index at d-line of each lens included in the focusing lens group and the variable aberration lens group. fW is the focal length of the variable magnification optical system in the wide-angle end state; Y is image height; BfW is the back focal length of the variable magnification optical system in the wide-angle end state.

### [Values for Conditional Expressions]

[Values for conditional expressions]

| Conditional | Examples | | | | |
|---|---|---|---|---|---|
| expressions | First | Second | Third | Fourth | Fifth |
| (1) f1/f2 | −0.462 | −0.157 | −3.261 | −3.599 | −4.322 |
| (2) Dsr1W/TLW | 0.061 | 0.084 | 0.111 | 0.127 | 0.075 |
| (3) Dsr1T/TLT | 0.078 | 0.097 | 0.112 | 0.110 | 0.134 |
| (4) Dsr2W/TLW | 0.158 | 0.153 | 0.143 | 0.254 | 0.130 |
| (5) Dsr2T/TLT | 0.205 | 0.255 | 0.139 | 0.259 | 0.157 |
| (6) Dsr1W/DsiW | 0.184 | 0.241 | 0.245 | 0.280 | 0.182 |
| (7) Dsr1T/DsiT | 0.150 | 0.191 | 0.242 | 0.243 | 0.317 |
| (8) Dsr2W/DsiW | 0.482 | 0.438 | 0.317 | 0.561 | 0.317 |
| (9) Dsr2T/DsiT | 0.394 | 0.501 | 0.302 | 0.569 | 0.371 |
| (10) ndLZ + | — | — | 2.202 | 2.202 | — |
| (0.01425*νdLZ) | | | | | |
| (11) νdLZ | — | — | 17.980 | 17.980 | — |
| (12) θgFLZ + | — | — | 0.711 | 0.711 | — |
| (0.00316*νdLZ) | | | | | |
| θgFLZ | — | — | 0.6546 | 0.6546 | — |
| (13) ndF | 1.768 | 1.746 | 1.801 | 1.946 | 1.847 |
| | 1.712 | 1.920 | 1.946 | 1.713 | 1.729 |
| | 1.952 | — | 1.713 | 1.903 | — |
| (14) \|fF1/fF2\| | 3.278 | 2.391 | 1.279 | 1.666 | 3.075 |
| (15) ndFDC | — | — | — | — | — |
| (16)(17) fl/fW | −1.965 | −2.297 | 2.028 | 2.151 | 1.158 |
| (18) Y/fW | 0.898 | 0.893 | 0.306 | 0.305 | 0.111 |
| (19) fW/BfW | 2.129 | 1.677 | 6.589 | 4.241 | 2.488 |

| Conditional | Examples | | | |
|---|---|---|---|---|
| expressions | Sixth | Seventh | Eighth | Ninth |
| (1) f1/f2 | −4.393 | −4.469 | −6.398 | −4.054 |
| (2) Dsr1W/TLW | 0.127 | 0.112 | — | — |
| (3) Dsr1T/TLT | 0.095 | 0.086 | — | — |
| (4) Dsr2W/TLW | 0.204 | 0.184 | — | — |
| (5) Dsr2T/TLT | 0.160 | 0.146 | — | — |
| (6) Dsr1W/DsiW | 0.250 | 0.213 | — | — |
| (7) Dsr1T/DsiT | 0.210 | 0.179 | — | — |
| (8) Dsr2W/DsiW | 0.402 | 0.349 | — | — |
| (9) Dsr2T/DsiT | 0.354 | 0.304 | — | — |
| (10) ndLZ + (0.01425*νdLZ) | — | — | 2.202 | 2.202 |
| (11) νdLZ | — | — | 17.980 | 17.980 |
| (12) θgFLZ + (0.00316*νdLZ) | — | — | 0.711 | 0.711 |
| θgFLZ | — | — | 0.6546 | 0.6546 |
| (13) ndF | 1.729 | 1.607 | — | — |
| | 1.699 | | | |
| (14) \|fF1/fF2\| | 2.002 | 1.133 | — | — |
| (15) ndFDC | — | — | 1.498 | 1.498 |
| | — | — | 1.498 | 1.498 |
| | — | — | 1.923 | 1.923 |
| | — | — | 1.498 | 1.498 |
| | — | — | 1.946 | 1.946 |
| | — | — | 1.713 | 1.713 |
| | — | — | 1.903 | 1.903 |
| (16)(17) fl/fW | 1.145 | 1.184 | 3.583 | 2.456 |
| (18) Y/fW | 0.106 | 0.109 | 0.306 | 0.307 |
| (19) fW/BfW | 2.469 | 1.954 | 4.859 | 4.210 |

The above examples are specific examples of the present invention, and the present invention is not limited thereto. The following details can be appropriately employed unless the optical performance of the variable magnification optical system of the embodiment of the present application is compromised.

The lens surfaces of lenses constituting the optical systems of the above examples may be spherical, plane, or aspherical surfaces. Spherical or plane lens surfaces are preferable because they facilitate lens machining, assembling, and adjustment and prevent a decrease in optical performance caused by errors in lens machining, assembling, and adjustment and because depiction performance does not decrease much even when the image plane is shifted. An aspherical lens surface may be a ground aspherical surface, a glass-molded aspherical surface made by molding glass into an aspherical shape, or a compound-type aspherical surface made by forming resin on a glass surface into an aspherical shape. Lens surfaces may be diffractive surfaces, and lenses may be graded index lenses (GRIN lenses) or plastic lenses.

The lens surfaces of the lenses constituting any of the variable magnification optical systems of the above examples may be covered with antireflection coating having high transmittance in a wide wavelength range. This reduces flares and ghosts, and enables achieving optical performance with high contrast.

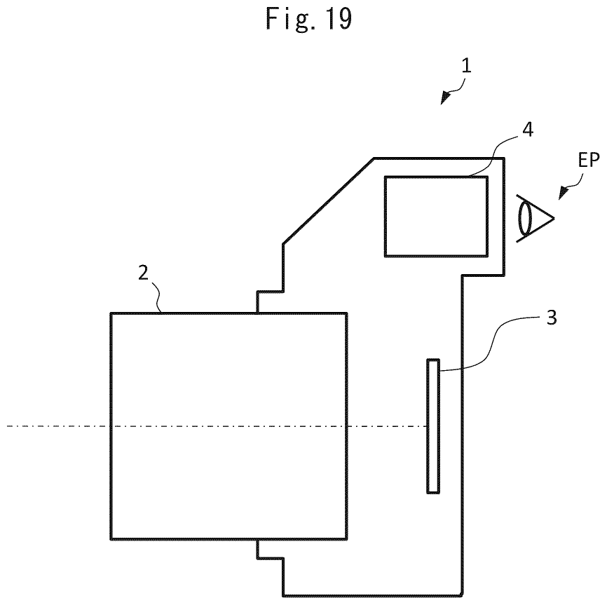

Next, a camera including the variable magnification optical system of the present embodiment will be described with reference to FIG. 19.

FIG. 19 schematically shows a camera including a variable magnification optical system of the present embodiment.

The camera 1 is a “mirror-less camera” of an interchangeable lens type including the variable magnification optical system according to the first example as an imaging lens 2.

In the camera 1, light from an object (subject) (not shown) is condensed by the imaging lens 2 and reaches an imaging device 3. The imaging device 3 converts the light from the subject to image data. The image data is displayed on an electronic view finder 4. This enables a photographer who positions his/her eye at an eye point EP to observe the subject.

When a release button (not shown) is pressed by the photographer, the image data is stored in a memory (not shown). In this way, the photographer can take a picture of the subject with the camera 1.

The variable magnification optical system of the first example included in the camera 1 as the imaging lens 2 is a variable magnification optical system of favorable optical performance. Thus the camera 1 can achieve favorable optical performance. A camera configured by including any of the variable magnification optical systems of the second to ninth examples as the imaging lens 2 can have the same effect as the camera 1.

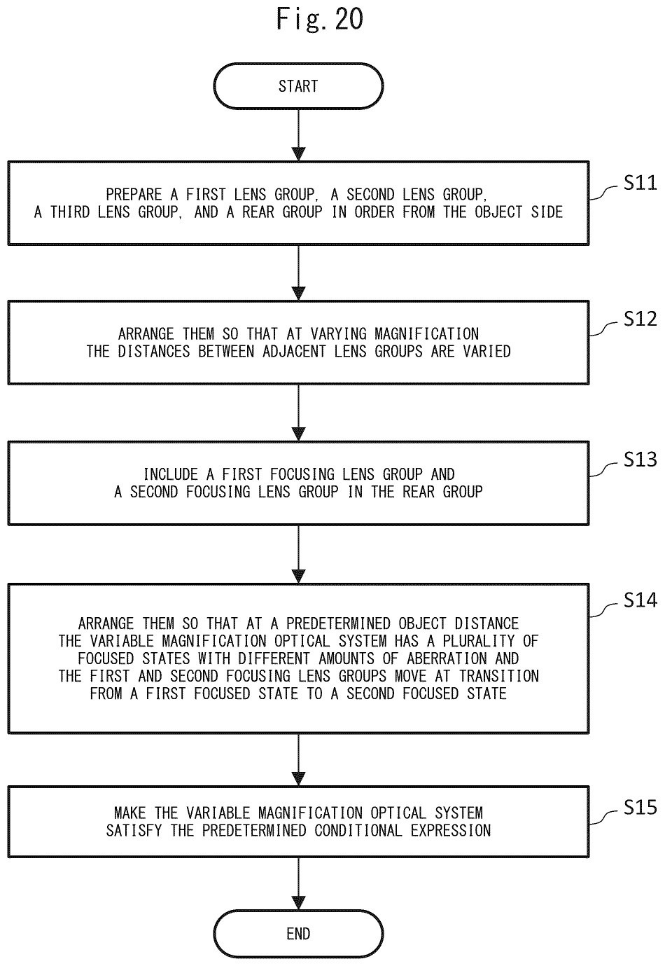

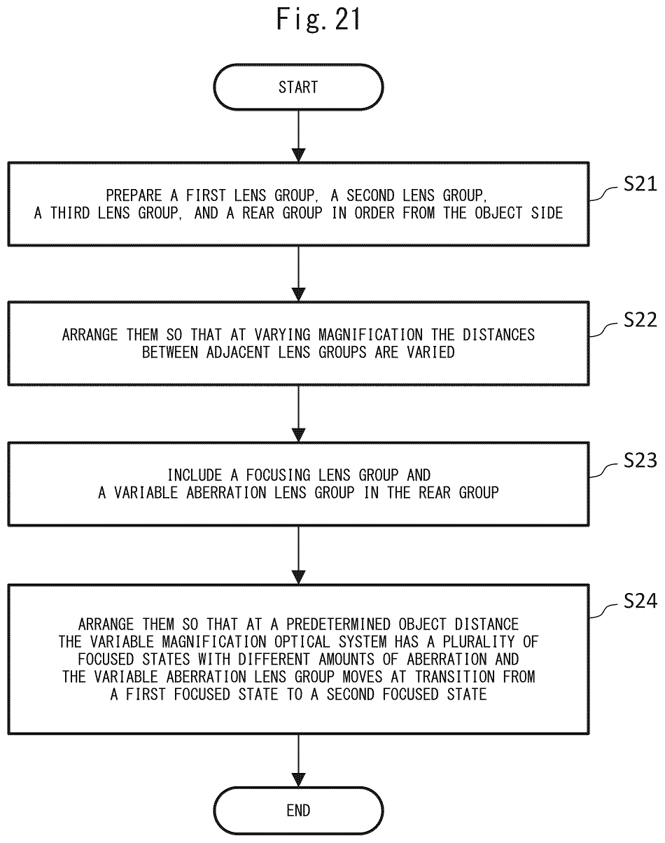

Finally, methods for manufacturing a variable magnification optical system of the present embodiment will be outlined with reference to FIGS. 20 and 21. FIGS. 20 and 21 are flowcharts outlining first and second methods for manufacturing a variable magnification optical system of the present embodiment, respectively.

The first method for manufacturing a variable magnification optical system of the present embodiment shown in FIG. 20 includes steps S11 to S15 below.

Step S11: a first lens group, a second lens group, a third lens group, and a rear group are prepared in order from the object side.

Step S12: they are arranged so that at varying magnification the distances between adjacent lens groups are varied.

Step S13: a first focusing lens group and a second focusing lens group are included in the rear group.

Step S14: they are arranged so that at a predetermined object distance the variable magnification optical system has a plurality of focused states with different amounts of aberration and the first and second focusing lens groups move at transition from a first focused state to a second focused state.

Step S15: the variable magnification optical system is made to satisfy the following conditional expression.

$$- 6.8 < f 1 / f 2 < - 0.05$$

where
f1: the focal length of the first lens group
f2: the focal length of the second lens group

The second method for manufacturing a variable magnification optical system of the present embodiment shown in FIG. 21 includes steps S21 to S24 below.

Step S21: a first lens group, a second lens group, a third lens group, and a rear group are prepared in order from the object side.

Step S22: they are arranged so that at varying magnification the distances between adjacent lens groups are varied.

Step S23: a focusing lens group and a variable aberration lens group are included in the rear group.

Step S24: they are arranged so that at a predetermined object distance the variable magnification optical system has a plurality of focused states with different amounts of aberration and the variable aberration lens group moves at transition from a first focused state to a second focused state.

A variable magnification optical system of favorable imaging performance can be manufactured by the method for manufacturing a variable magnification optical system of the present embodiment.

It should be noted that those skilled in the art can make various changes, substitutions, and modifications without departing from the spirit and scope of the present disclosure.

What is claimed is:

1. A variable magnification optical system comprising a first lens group, a second lens group, a third lens group, and a rear group in order from an object side,
at varying magnification the distances between adjacent lens groups being varied,
at a predetermined object distance the variable magnification optical system having a plurality of focused states with different amounts of aberration,
the rear group including a first focusing lens group and a second focusing lens group disposed closer to an image side than the first focusing lens group, the first and second focusing lens groups moving along different trajectories at focusing,
at the predetermined object distance the first and second focusing lens groups moving at transition from a first focused state to a second focused state, the first and second focused states being among the plurality of focused states and having different amounts of aberration,
the variable magnification optical system satisfying the following conditional expression.
$$- 6.8 < f 1 / f 2 < - 0.05$$
where
f1: the focal length of the first lens group
f2: the focal length of the second lens group

2. The variable magnification optical system according to claim 1, wherein at the predetermined object distance the first and second focusing lens groups move in the same direction at transition from the first focused state to the second focused state.

3. The variable magnification optical system according to claim 1, wherein one of the first and second focusing lens groups has positive refractive power, and the other has negative refractive power.

4. The variable magnification optical system according to claim 1, wherein the first and second focusing lens groups are disposed between an aperture stop and an image plane.

5. The variable magnification optical system according to claim 4, wherein the following conditional expressions are satisfied.
$$\begin{matrix}- 0.2 < Dsr 1 W / TLW < 0.2 \\ - 0.25 < Dsr 1 T / TLT < 0.25\end{matrix}$$
where
Dsr1W: the distance on the optical axis between the aperture stop and an object-side surface of a lens disposed closest to the object side in the first focusing lens group at focusing on infinity in the wide-angle end state
TLW: the total length of the optical system in the wide-angle end state
Dsr1T: the distance on the optical axis between the aperture stop and an object-side surface of a lens disposed closest to the object side in the first focusing lens group at focusing on infinity in the telephoto end state
TLT: the total length of the optical system in the telephoto end state

6. The variable magnification optical system according to claim 4, wherein the following conditional expressions are satisfied.
$$\begin{matrix}0.1 < Dsr 2 W / TLW < 0.4 \\ 0.1 < Dsr 2 T / TLT < 0.4\end{matrix}$$
where
Dsr2W: the distance on the optical axis between the aperture stop and an object-side surface of a lens disposed closest to the object side in the second focusing lens group at focusing on infinity in the wide-angle end state
TLW: the total length of the optical system in the wide-angle end state
Dsr2T: the distance on the optical axis between the aperture stop and an object-side surface of a lens disposed closest to the object side in the second focusing lens group at focusing on infinity in the telephoto end state
TLT: the total length of the optical system in the telephoto end state

7. The variable magnification optical system according to claim 4, wherein the following conditional expressions are satisfied.
$$\begin{matrix}Dsr 1 W / DsiW < 0.3 \\ Dsr 1 T / DsiT < 0.35\end{matrix}$$
where
DsiW: the distance on the optical axis between the aperture stop and the image plane at focusing on infinity in the wide-angle end state
DsiT: the distance on the optical axis between the aperture stop and the image plane at focusing on infinity in the telephoto end state

8. The variable magnification optical system according to claim 4, wherein the following conditional expressions are satisfied.
$$\begin{matrix}0.2 < Dsr 2 W / DsiW \\ 0.25 < Dsr 2 T / DsiT\end{matrix}$$
where
DsiW: the distance on the optical axis between the aperture stop and the image plane at focusing on infinity in the wide-angle end state
DsiT: the distance on the optical axis between the aperture stop and the image plane at focusing on infinity in the telephoto end state

9. The variable magnification optical system according to claim 1, wherein at least one of the first and second focusing lens groups includes at least one lens Z satisfying the following conditional expressions:
$$\begin{matrix}ndLZ + ( 0.01425 \times vdLZ ) < 2.25 \\ vdLZ < 35. \\ 0.702 < θ gFLZ + ( 0.00316 \times vdLZ )\end{matrix}$$
where
ndLZ: the refractive index of the lens Z at d-line
νdLZ: the Abbe number of the lens Z based on d-line
θgFLZ: the partial dispersion ratio of the lens Z defined by the following expression:
θgFLZ=(ngLZ−nFLZ)/(nFLZ−nCLZ)
where ngLZ, nFLZ, and nCLZ denote the refractive indices of the lens Z at g-line, F-line, and C-line, respectively.

10. The variable magnification optical system according to claim 1, wherein the first or second focusing lens group includes at least one lens satisfying the following conditional expression.
1.60<ndF<2.00
where
ndF: the refractive index at d-line of the lens included in the first or second focusing lens group

11. The variable magnification optical system according to claim 1, wherein the following conditional expression is satisfied.
$$0. < \vert fF 1 / fF 2 \vert < 4.$$
where
fF1: the focal length of the first focusing lens group
fF2: the focal length of the second focusing lens group

12. A variable magnification optical system comprising a first lens group, a second lens group, a third lens group, and a rear group in order from an object side,
at varying magnification the distances between adjacent lens groups being varied,
at a predetermined object distance the variable magnification optical system having a plurality of focused states with different amounts of aberration,
the rear group including a focusing lens group that moves at focusing, and a variable aberration lens group that differs from the focusing lens group and that moves at the predetermined object distance at transition from a first focused state to a second focused state, the first and second focused states being among the plurality of focused states and having different amounts of aberration.

13. The variable magnification optical system according to claim 12, wherein the variable aberration lens group is disposed between an aperture stop and an image plane.

14. The variable magnification optical system according to claim 12, wherein at least one of the focusing lens group and the variable aberration lens group includes at least one lens Z satisfying the following conditional expressions:
$$\begin{matrix}ndLZ + ( 0.01425 \times vdLZ ) < 2.25 \\ vdLZ < 35. \\ 0.702 < θ gFLZ + ( 0.00316 \times vdLZ )\end{matrix}$$
where
ndLZ: the refractive index of the lens Z at d-line
νdLZ: the Abbe number of the lens Z based on d-line
θgFLZ: the partial dispersion ratio of the lens Z defined by the following expression:
θgFLZ=(ngLZ−nFLZ)/(nFLZ−nCLZ)
where ngLZ, nFLZ, and nCLZ denote the refractive indices of the lens Z at g-line, F-line, and C-line, respectively.

15. The variable magnification optical system according to claim 12, wherein the focusing lens group and the variable aberration lens group are composed of a lens satisfying the following conditional expression.
1.49<ndFDC<1.95
where
ndFDC: the refractive index at d-line of each lens included in the focusing lens group and the variable aberration lens group

16. The variable magnification optical system according to claim 1, wherein the following conditional expression is satisfied.
$$- 2.5 < f 1 / fW < - 1.$$
where
f1: the focal length of the first lens group
fW: the focal length of the variable magnification optical system in the wide-angle end state

17. The variable magnification optical system according to claim 1, wherein the following conditional expression is satisfied.
$$1. < f 1 / fW < 4.$$
where
f1: the focal length of the first lens group
fW: the focal length of the variable magnification optical system in the wide-angle end state

18. The variable magnification optical system according to claim 1, wherein the following conditional expression is satisfied.
$$0.1 < Y / fW < 1.$$
where
Y: image height
fW: the focal length of the variable magnification optical system in the wide-angle end state

19. The variable magnification optical system according to claim 1, wherein the following conditional expression is satisfied.
$$1.5 < fW / BfW < 7.$$
where
BfW: the back focal length of the variable magnification optical system in the wide-angle end state
fW: the focal length of the variable magnification optical system in the wide-angle end state

20. An optical device comprising the variable magnification optical system according to claim 1.

21. A method for manufacturing a variable magnification optical system comprising a first lens group, a second lens group, a third lens group, and a rear group in order from an object side, the method comprising configuring the lens groups so that
at varying magnification the distances between adjacent lens groups are varied,
at a predetermined object distance the variable magnification optical system has a plurality of focused states with different amounts of aberration,
the rear group includes a first focusing lens group and a second focusing lens group disposed closer to an image side than the first focusing lens group, the first and second focusing lens groups moving along different trajectories at focusing,
at the predetermined object distance the first and second focusing lens groups move at transition from a first focused state to a second focused state with a different amount of aberration, and
the following conditional expression is satisfied.
$$- 6.8 < f 1 / f 2 < - 0.05$$
where
f1: the focal length of the first lens group
f2: the focal length of the second lens group
